(19) United States
(12) Patent Application Publication
(10) Pub. No.: US 2004/0190542 A1
(43) Pub. Date: Sep. 30, 2004

(54) Mobile node, packet relay device and packet forwarding method

(76) Inventors: Hideaki Ono, Kawasaki (JP); Haruyuki Takeyoshi, Kawasaki (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/786,411

(22) Filed: Feb. 26, 2004

(30) Foreign Application Priority Data
Mar. 31, 2003 (JP) 2003-096986

(51) Int. Cl. H04J 3/26

(52) U.S. Cl. 370/432; 370/390

(57) ABSTRACT

A packet relay device comprises a join request unit operable to transmit a join request to join a multicast group in response to receiving a join instruction to join the multicast group, the join instruction transmitted by a mobile node at least before the mobile node moves between subnetworks and a packet forwarding unit operable to forward subsequently received multicast packets for the multicast group for a specified time period to a care-of address in response to receiving location registration information containing the care-of address of the mobile node in a foreign subnetwork to which the mobile node has moved, the location registration information transmitted when the mobile node has moved between subnetworks.

### CROSS-REFERENCE TO RELATED APPLICATIONS

This application is based upon and claims the benefit of priority from the prior Japanese Patent Application No. 2003-096986, filed in Mar. 31, 2003, the entire contents of which are incorporated herein by reference.

### BACKGROUND OF THE INVENTION

1. Field of the Invention

The present invention relates to packet communication technology, in particular, to mobile node multicast packet communication technology.

2. Description Of Related Art

With the spread of the Internet, packet communication using the Internet Protocol (IP) has currently become widespread.

Moreover, mobile IP, which would make mobile communication using IP possible, is being studied by the IETF (Internet Engineering Task Force), and mobile communication using mobile IP is becoming more and more possible.

Mobile IP is a technology that, by associating the home address (HoA) of a mobile node (MN)—which is its address in the home network, which is the subnetwork to which the mobile node fundamentally belongs—and the MN's care-of address (CoA)—which is its address in the foreign subnetwork to which it has currently moved—and registering those addresses with a home agent (HA), allows communication to be continued even when the MN moves.

FIG. 31 is a drawing that explains the method of communication using mobile IP.

In FIG. 31, it is assumed that MN 301 is initially connected to a subnetwork of which the access router (AR) (1) 201 is part. When the MN moves into the subnetwork of which AR (1) 201 is part, it obtains a care-of address CoA (1) and registers it with the HA 110 using a location registration (binding update; BU) message (S901), and HA 110 stores the correspondence information between the mobile node's home address (HoA (1)) and care-of address (CoA (1)) in the form of a binding cache 111 (S902).

Meanwhile, the correspondent node (CN) 401, which is the party communicating with MN 301, transmits packets addressed to the home address (HoA (1)) of MN 301.

HA 110 captures packets addressed to HoA (1) (S903), encapsulates those packets by addressing them to the CoA (1) obtained as a result of a lookup in binding cache 111, and transmits them (S904).

Since these encapsulated packets are addressed to the CoA (1) currently being used by MN 301, MN 301 becomes able to receive these packets at its current foreign location.

Upon receiving these packets, MN 301 decapsulates them to extract the original packets addressed to HoA (1), thereby enabling it communicate with CN 401.

Next, MN 301 moves to the subnetwork of which AR (1) 202 is part, as shown by the dotted line in FIG. 31.

Immediately after moving to AR (2) 202, MN 301 acquires the care-of address CoA (2) that it will use in the foreign subnetwork to which it has moved, and registers it with HA 110 using a BU message (S911).

HA 110 receives this notification and overwrites CoA (1), which had been registered as the CoA corresponding to HoA (1) in the binding cache, with CoA (2) (S912).

Subsequently, packets transmitted by CN 401 addressed to HoA (1) of MN 301 (S913) are encapsulated and forwarded to the address CoA (2) by HA 110 (S914), allowing MN 301 to continue communicating with CN 401.

Furthermore, if the aforementioned CN 401 supports mobile IP then in addition to the method of encapsulating and forwarding packets from CN 410 via the aforementioned HA 110, there is the method whereby, if a packet from CN 401 has passed via HA 110 (encapsulated forwarding), MN 301 will transmit a BU message to CN 401 and cause CN 401 to transmit packets directly (without passing through the HA) to the care-of address.

The study of multicast technology for packet communication has also been progressing at the IETF. Study has been progressing for instance on IGMP (Internet Group Management Protocol) and MLD (Multicast Listener Discovery) as communication protocols between host and router, and on PIM (Protocol Independent Multicast) as a multicast routing protocol between routers.

FIG. 32 is a diagram that explains packet forwarding in multicast communication.

In FIG. 32, the sender 501 is the transmitter of multicast packets of multicast group G, and the receiver (a) 701 and receiver (b) 702 are recipients of the aforementioned multicast packets. MR (1) 601 through MR (5) 605 are multicast routers that implement protocols used in multicast forwarding, such as IGMP and PIM.

The forwarding tree for multicast group G, leading from the sender 501 to the receiver (a) 701 and receiver (b) 702, is generated based on the multicast routing protocol.

Namely, when the sender 501 transmits a multicast packet to the multicast group address MCA (G) (S921), it is forwarded along the route MR (1) 601, MR (2) 602, MR (3) 603, receiver (a) 701, and the route MR (1) 601, MR (2) 602, MR (4) 604, receiver (b) 702 (S922).

Here, MR (2) 602 copies and transmits the multicast packets addressed to MCA (G) to MR (3) 603 and MR (4) 604. Furthermore, MR (2) 602 does not copy and transmit to MR (5) 605. This is because there are no receivers of multicast group G in the subnetwork of which MR (5) 605 is part, and no branch of the forwarding tree going from MR (2) 602 to MR (5) 605 is generated.

If a receiver wants to join a multicast group, the receiver transmits a join message (also called multicast listener report or membership report) to the MR of the subnetwork of which the receiver is part.

Then when leaving the multicast group in which it is participating, the receiver transmits a leave message.

The join message contains the multicast group address that one wishes to join. When the multicast router received the join message, then the forwarding tree needed for multicast forwarding is created. If a node participating in the multicast group in question disappears based on a leave message, the forwarding tree is pruned.

In FIG. 32, when the receiver (c) 703 served by MR (5) 605 transmits a join message for joining multicast group G to MR (5) 605, since there are no other receivers that have joined multicast group G and no multicast packets addressed to MCA (G) are being received, i.e. since no branch of the forward tree extends to it, MR (5) 605 transmits a join message to the higher level MR (2) 602.

Upon receiving this message, since a branch of the forwarding tree for multicast group G extends to it, MR (2) 602 rewrites its internal information so as to extend a branch of the forward tree to MR (5) 605 in addition to MR (3) 603 and MR (4) 604, i.e. so that multicast packets addressed to MCA (G) that it receives will be copied and transmitted to MR (5) 605 as well.

This makes it possible for receivers served by MR (5) 605 to receive multicast packets addressed to MCA (G).

As mobile nodes become more widespread in packet networks, such as in a mobile IP compatible network, the possibility arises of mobile nodes performing multicast communication.

Multicast communication is possible even if mobile IP technology is not used. But, considering the terminal is communicating while moving, performing multicast communication with mobile nodes has the following problems.

In multicast communication, the host transmits the join message for the multicast group that it wishes to join, for instance G, to the designated router (DR). The DR is the router that manages the multicast operations in the segment of which it is part; in FIG. 32, the DR for the receiver (a) 701 is MR (3) 603.

If there are already receivers participating in the same multicast group G within the link of which a DR is part, then a branch of the forwarding tree for receiving multicast packets addressed to the multicast group G would have already been created based on the multicast routing protocol.

If there are no other receivers participating in multicast group G, then the DR activates the multicast routing protocol to newly create a branch of the forwarding tree for receiving multicast packets addressed to multicast group G, and reception of multicast packets addressed to multicast group G becomes possible only after a branch of the forwarding tree has been extended to the DR.

Although this varies depending on the environment, such as the number of routers between the sender and the receiver, the time needed to newly create a branch of the forwarding tree here is usually from several hundred milliseconds to several seconds or more.

Here, if the aforementioned receiver is a fixed node belonging to a fixed subnetwork, then this time is time required until start of communication, after which reception of multicast packets is carried out continuously, so this is not a big problem.

On the other hand, if the aforementioned receiver is a mobile node, then when a move (handover) is carried out, if no branch of the forwarding tree extends to the handover destination DR, then there is the possibility that several seconds or more will be needed to create this branch, as described above, during which time multicast packets addressed to the multicast group cannot be received at the mobile node, leading to data drops and the resultant retransmissions, so there is the problem of decreased quality.

FIG. 33 is a drawing that explains the communication method for performing multicast communication in mobile IP.

In FIG. 33, it is assumed that MN 301 is a mobile node and is at the same time a receiver participating in multicast group G, and that it moves from the subnetwork of AR (1) 201 to the subnetwork of AR (2) 202 and the subnetwork of AR (3) 203.

It is assumed that AR (1) 201 is a multicast router, that a branch of the forwarding tree for multicast group G has already been created to it, and that reception of multicast packets is possible.

It is assumed that AR (2) 202 is a multicast router, and that there are no receivers participating in multicast group G in its subnetwork at this time, so no branch of the forwarding tree for multicast group G has been created to it.

In this state, when MN 301 moves to the subnetwork of AR (2) 202, MN 301 first sends a join message for joining multicast group G to AR (2) 202 (S931), and AR (2) 202 sends another join message to the upstream multicast router MR (2) 602 so as to extend a branch of the forwarding tree to itself (S932).

Subsequently, once a branch of the forwarding tree to AR (2) 202 has been generated, reception of multicast packets addressed to multicast group G become possible at MN 301 (S933).

Therefore, MN 301 becomes unable to receive multicast packets for a time when it moves, so the packet forwarding quality declines.

Furthermore, the multicast communication scheme assumes that there are multicast routers within the subnetwork. Thus, there is the problem that it will become impossible to continue multicast communication if MN 301 moves to a subnetwork in which there is no multicast router.

In FIG. 33, it is assumed that AR (3) 203 is a router that is not multicast compatible.

Assuming that MR 301 has further moved from AR (2) 202 to AR (3) 203, after the move, MN 301 transmits a join message for joining multicast group G to AR (3) 203 (S934), but AR (3) 203 cannot process this message, and no branch of the forwarding tree to AR (3) 203 is generated.

In this case, reception of multicast packets becomes impossible at the time of the move.

The present invention was created in view of such problems, and has the objective of reducing the loss of multicast packets occurring when a mobile node moves between subnetworks and improving data forwarding quality.

### SUMMARY OF THE INVENTION

To resolve the aforementioned problems, the present invention adopts the following constitutions.

The packet relay device of the present invention is constituted such that it comprises: a join request means that, upon receiving a join instruction to join a multicast group, transmitted by a mobile node at least before the mobile node moves between subnetworks, transmits a join request to join the aforementioned multicast group; and a packet forwarding means that, upon receiving location registration information containing the care-of address of the aforementioned mobile node in the foreign subnetwork to which it has moved, transmitted when the aforementioned mobile node has moved between subnetworks, forwards subsequently received multicast packets for the aforementioned multicast group for a specific time period to the aforementioned care-of address.

The aforementioned packet forwarding means may optionally be constituted such that, upon receiving a forwarding stop instruction transmitted by the aforementioned mobile node, it stops forwarding of the aforementioned multicast packets.

Furthermore, the aforementioned packet forwarding means may optionally be constituted such that, upon receiving time period designation information indicating the aforementioned specific time period, transmitted by the aforementioned mobile node, it determines the forwarding time period for the aforementioned multicast packets based on the aforementioned time period designation information.

Moreover, the mobile node of the present invention, which is a mobile node that transmits join requests to join multicast groups to a relay device with a multicast packet delivery function, and receives multicast packets for the aforementioned multicast group that are received and delivered by said relay device, is constituted such that it comprises: a join instruction means that transmits join instructions to join a multicast group to a location registrar relay device, which is the recipient of location registration information containing one's own care-of address, at least before moving between subnetworks; and a forwarding request means that, upon moving between subnetworks while participating in said multicast group, transmits a forwarding request to the aforementioned location registrar relay device, which causes the multicast packets for said multicast group subsequently received by the aforementioned location registrar relay device to be forwarded for a specific time period to the care-of address of the aforementioned mobile node after the move.

Furthermore, the mobile node of the present invention may optionally be constituted such that, when newly joining a multicast group, it transmits a join request to join the aforementioned multicast group to a relay device in the subnetwork of which it is part, and the aforementioned join instruction means transmits a join instruction to join the aforementioned multicast group to the aforementioned location registrar relay device.

Furthermore, the mobile node of the present invention may optionally be constituted such that it comprises a forwarding stop instruction means which, once multicast packets are received from a multicast group based on a join request after transmitting a join instruction to join the multicast group, transmits, to the aforementioned location registrar relay device, a forwarding stop instruction to stop forwarding by the aforementioned location registrar relay device.

Furthermore, the mobile node of the present invention may optionally be constituted such that it comprises a time period designation means which, when the foreign subnetwork to which the node has moved has a multicast packet delivery function, transmits information indicating a set time period as the aforementioned specific time period to the aforementioned location registrar relay device, and, when the foreign subnetwork to which the node has moved has no multicast packet delivery function, transmits information indicating that forwarding should be continued as the aforementioned specific time period to the aforementioned location registrar relay device.

Moreover, the packet forwarding method of the present invention is a method whereby a mobile node that receives multicast packets notifies the home agent for said mobile node whether the foreign subnetwork to which it has moved is a multicast protocol compatible subnetwork, and if, based on the content of that notification, the foreign subnetwork to which the mobile node has moved is a multicast protocol compatible subnetwork, then the aforementioned home agent encapsulates and forwards the aforementioned multicast packets to the foreign care-of address of the aforementioned mobile node for a specific period of time, or if the foreign subnetwork is not a multicast protocol compatible subnetwork, then the aforementioned home agent continues to encapsulate and forward the aforementioned multicast packets to the aforementioned care-of address regardless of the aforementioned specific time period.

Furthermore, the packet forwarding method of the present invention is a method whereby a mobile node that receives multicast packets notifies a relay device to which it was connected in the subnetwork it is moving from whether the foreign subnetwork it is moving to is a multicast protocol compatible subnetwork, and if, based on the content of that notification, the foreign subnetwork to which the mobile node has moved is a multicast protocol compatible subnetwork, then the aforementioned relay device encapsulates and forwards the aforementioned multicast packets for a specific time period to the care-of address of the aforementioned mobile node in the foreign network to which it has moved or if the aforementioned foreign subnetwork to which the mobile node has moved is not a multicast protocol compatible subnetwork, then the aforementioned relay device continues to encapsulate and forward the aforementioned multicast packets to the aforementioned care-of address regardless of the aforementioned specific time period.

In one embodiment of the present invention, a packet relay device comprises a join request unit operable to transmit a join request to join a multicast group in response to receiving a join instruction to join the multicast group, the join instruction transmitted by a mobile node at least before the mobile node moves between subnetworks and a packet forwarding unit operable to forward subsequently received multicast packets for the multicast group for a specified time period to a care-of address in response to receiving location registration information containing the care-of address of the mobile node in a foreign subnetwork to which the mobile node has moved, the location registration information transmitted when the mobile node has moved between subnetworks,.

In one aspect of the present invention, the packet forwarding means is further operable to stop forwarding of the multicast packets in response to receiving a forwarding stop instruction transmitted by the mobile node.

In one aspect of the present invention, the packet forwarding means is further operable to determine a forwarding time period for the multicast packets based on time period designation information in response to receiving the time period designation information indicating a specified time period, the time period designation information transmitted by the mobile node.

### BRIEF DESCRIPTION OF THE DRAWINGS

FIG. 1 is a drawing that illustrates a first embodiment example of the present invention.

FIG. 2 is a drawing that shows an example of the packet arrival time period table that a mobile node is provided with.

FIG. 3 is a drawing (1) that illustrates a second embodiment example of the present invention.

FIG. 4 is a drawing that shows an example of the content held in a binding cache.

FIG. 5 is a drawing that shows an example of a multicast table.

FIG. 6 is a drawing (2) that illustrates a second embodiment example of the present invention.

FIG. 7 is a drawing (3) that illustrates a second embodiment example of the present invention.

FIG. 8 is a drawing (4) that illustrates a second embodiment example of the present invention.

FIG. 9 is a drawing that shows an example configuration of a home agent (HA).

FIG. 10 is a drawing that shows an example configuration of a mobile node (MN).

FIG. 11 is a flow chart of the multicast packet forwarding processing unit of an HA.

FIG. 12 is a flow chart of the encapsulation processing unit of an HA.

FIG. 13 is a flow chart (1) of the mobile IP message processing unit of an HA.

FIG. 14 is a flow chart (2) of the mobile IP message processing unit of an HA.

FIG. 15 is a drawing that shows an example configuration of the multicast table of an HA.

FIG. 16 is a drawing that shows an example configuration of the binding cache of an HA.

FIG. 17 is a drawing that shows an example configuration of a BU message.

FIG. 18 is a flow chart of the operation of the mobile IP message processing unit of an MN at the time of moving.

FIG. 19 is a flow chart of the operation of the mobile IP message processing unit of an MN at the time of terminating communication.

FIG. 20 is a flow chart of the operation of the mobile IP message processing unit of an MN at the time of stopping redundant encapsulated forwarding.

FIG. 21 is a drawing (1) that illustrates a fourth embodiment example of the present invention.

FIG. 22 is a drawing (2) that illustrates a fourth embodiment example of the present invention.

FIG. 23 is a drawing that shows an example configuration of an access router (AR).

FIG. 24 is a flow chart of the multicast packet forwarding processing unit of an AR.

FIG. 25 is a flow chart of the encapsulation processing unit of an AR.

FIG. 26 is a flow chart (1) of the mobile IP message processing unit of an AR.

FIG. 27 is a flow chart (2) of the mobile IP message processing unit of an AR.

FIG. 28 is a flow chart of the operation at the time of moving of the mobile IP message processing unit of an MN in the fourth embodiment example.

FIG. 29 is a flow chart of the operation at the time of terminating communication of the mobile IP message processing unit of an MN in the fourth embodiment example.

FIG. 30 is a flow chart of the operation at the time of stopping redundant encapsulated forwarding of the mobile IP message processing unit of an MN in the fourth embodiment example.

FIG. 31 is a drawing that illustrates the communication method using mobile IP.

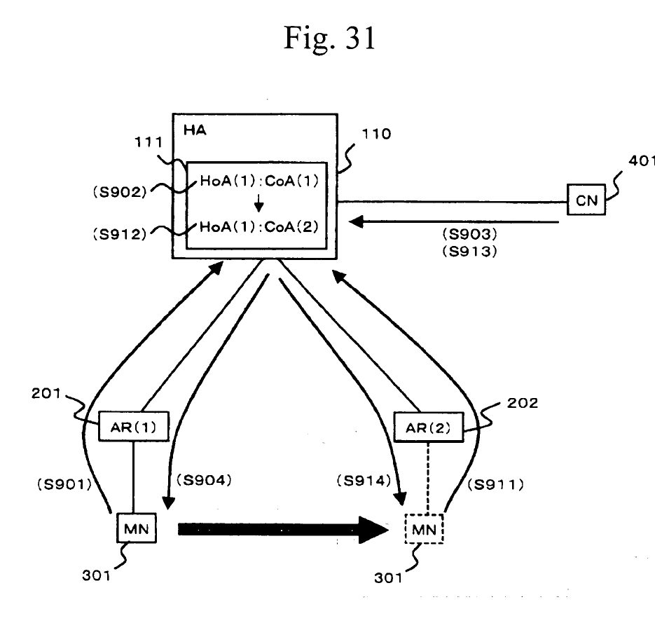

FIG. 32 is a drawing that illustrates packet forwarding in multicast communication.

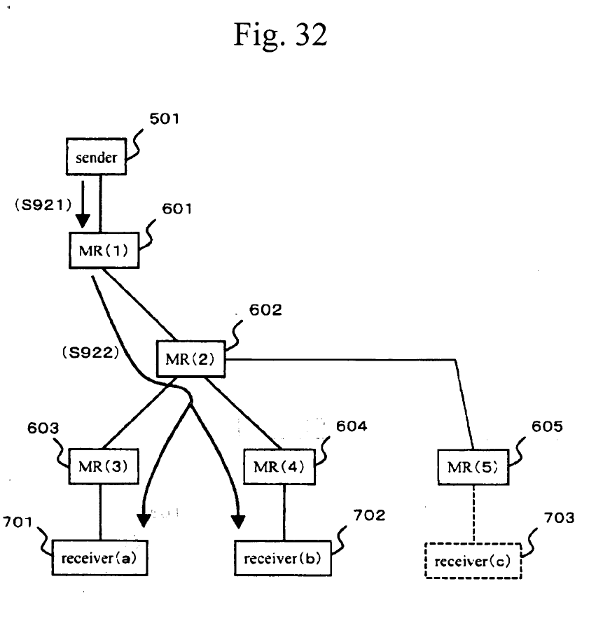

FIG. 33 is a drawing that illustrates the communication method for performing multicast communication using mobile IP.

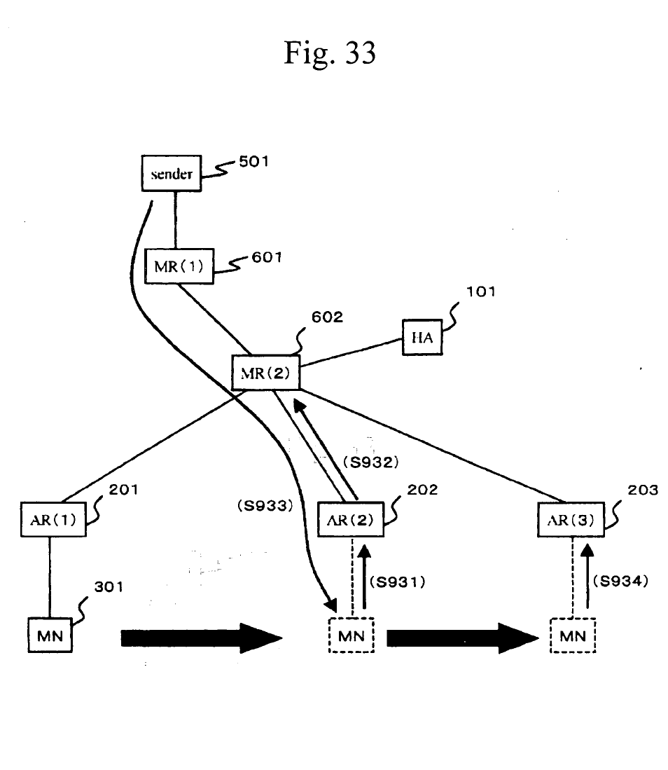

### DETAILED DESCRIPTION OF THE INVENTION

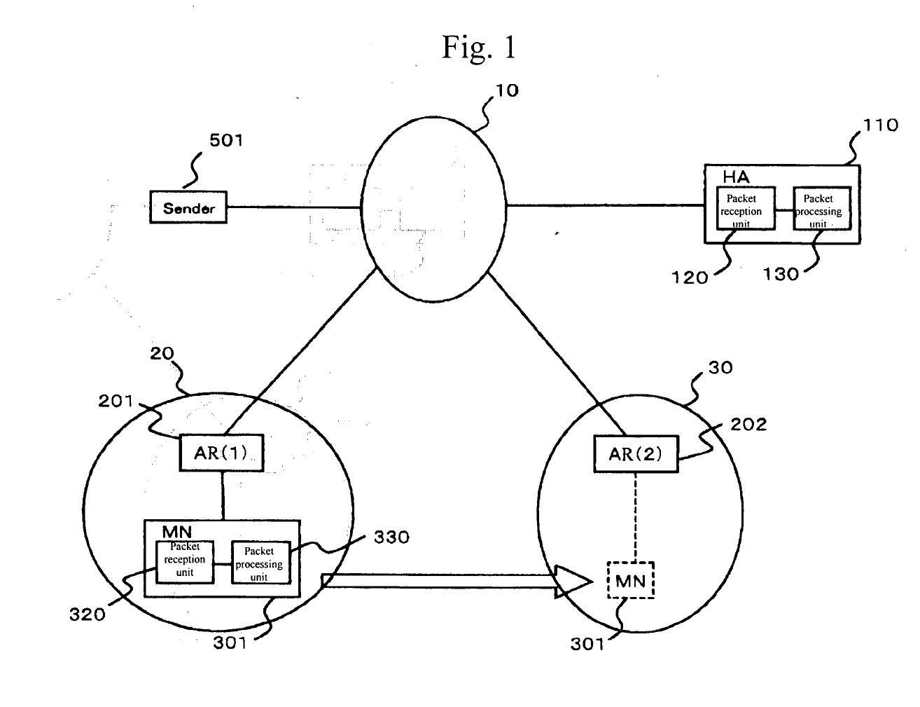

FIG. 1 is a drawing that explains a first example of embodiment of the present invention, which is an IP network using Internet Protocol (IP). In FIG. 1, mobile node MN 301 is a mobile node that transmits join requests (hereinafter referred to as join messages) to join a multicast group to a relay device with a multicast packet delivery function, and receive multicast packets for the aforementioned multicast group that are received and delivered by the aforementioned relay device.

Furthermore, MN 301 comprises a packet processing unit 330 as the join instruction means that transmits join instructions to join a multicast group, for instance G, to the home agent HA 110, which is the location registrar relay device that is the recipient of location registration information (hereinafter referred to as BU message) containing one's own care-of address, at least before moving between subnetworks.

Moreover, this packet processing unit 330 also functions as a forwarding request means that, when MN 301 moves between subnetworks while participating in multicast group G, transmits a forwarding request to HA 110, which causes the multicast packets for multicast group G subsequently received by HA 110 to be forwarded for a specific time period to the care-of address of MN 301 after the move.

Although here, the packet processing unit 330 was made to serve as both the aforementioned join request means and the aforementioned forwarding request means, these means may also be constituted as separate units.

Furthermore, HA 110 comprises a packet processing unit 130 as the join request means that, upon receiving a join instruction to join a multicast group, transmitted by MN 301 at least before moving between subnetworks, transmits a join message for multicast group G.

Furthermore, upon receiving a BU message containing the care-of address CoA (2) of MN 301 in foreign subnetwork 30, transmitted by MN 301 when it has moved between subnetworks, the packet processing unit 130 also functions a packet forwarding means that forwards subsequently received multicast packets for the aforementioned multicast group to the aforementioned care-of address for a specific time period.

Although here, the packet-processing unit 130 was made to serve as both the join request means and the packet forwarding means, these means may also be constituted as separate units.

Furthermore, MN 301 has a home address HoA, which is its address in its base subnetwork, and HA 110 is part of a home link that defines the subnet prefix of the HoA of MN 301.

First, it is assumed that MN 301 is attached to subnetwork 20 and is connected to AR (1) 201.

While attached to this subnetwork 20, when newly joining a multicast group G, MN 301 transmits a join message to AR (1) 201.

Thereupon, it becomes possible for MN 301 to received multicast packets for multicast group G transmitted by the sender 501 via the packet network 10 and AR (1) 201. That is, a state is obtained whereby a branch of the forwarding tree for multicast group G is created from the sender 501 to MN 301.

Moreover, for instance on the occasion of transmitting the aforementioned join message, MN 301 transmits a join instruction to join multicast group G to HA 110 by means of the packet processing unit 330.

Upon receiving this join instruction, HA 110 transmits a join message to join multicast group G by means of the packet processing unit 130, leading to a state where multicast packets for multicast group G transmitted by the sender 501 can be received. That is, a state is obtained whereby a branch of the forwarding tree for multicast group G is created from the sender 501 to HA 110.

In this state, upon moving from subnetwork 20 to subnetwork 30, MN 301 receives a router advertisement issued by AR (2) 202, which contains identification information for subnetwork 30, and becomes aware of the movement between subnetworks.

The MN 301 transmits a join message to join multicast group G to AR (2) 202, which is a multicast protocol compatible router of foreign subnetwork 30.

At this time, if AR (2) 202 has no receivers that are participating in multicast group G, there will be no branch of the forwarding tree for multicast group G extending to AR (2) 202 and AR (2) 202 will transmit a join message to a higher level router in order to get a branch of the forwarding tree extended to itself, but for a time until the branch of the forwarding tree has been extended to it, multicast packets for multicast group G will not reach AR (2) 202.

Therefore, for the time until AR (2) 202 receives and relays multicast packets for the aforementioned multicast group G and MN 301 becomes able to receive them, no multicast packets for the aforementioned multicast group G can be received via this route (hereinafter called direct forwarding route).

Moreover, upon becoming aware that it has moved to subnetwork 30, MN 301 transmits to HA 110, by means of the packet processing unit 330, a BU message that serves as a forwarding request that causes multicast packets for multicast group G subsequently received by HA 110 to be forwarded for a specific time period to the care-of address CoA (2) of MN 301 after the move.

Upon receiving this BU message, HA 110, by means of the packet processing unit 130, forwards the subsequently received multicast packets for the aforementioned multicast group for a specific time period to CoA (2), for instance by encapsulating them.

Then, upon receiving these encapsulated packets, MN 301 decapsulates them to obtain the multicast packets for multicast group G.

Namely, by this route (hereinafter referred to as encapsulated forwarding route), it is possible to acquire multicast packets of the subscribed multicast group G for the aforementioned specific time period (hereinafter referred to as encapsulated forwarding time period).

As described above, when the MN moves and creation of a new direct forwarding route becomes necessary, even during the time period when multicast packets for a multicast group to which the MN is subscribed cannot be received by this route, these multicast packets can be received, for a specific time period, via the encapsulated forwarding route, making it possible to reduce packet loss occurring when MN 301 moves between subnetworks and to improve the data forwarding quality.

Moreover, HA 110 does not perform forwarding after expiration of the aforementioned encapsulated forwarding period, and in order to sever the branch of the forwarding tree and stop multicast packets for multicast group G from being forwarded when there are no receivers other than MN 301 participating in multicast group G, one may optionally transmit a leave message to leave multicast group G and keep the HA 110 from receiving unneeded packets.

In terms of the methods by that the aforementioned packet processing unit 130 performs processing during the encapsulated forwarding time period, there is the method of providing a hardware or software timer, starting the aforementioned timer for the encapsulated forwarding time period once a foreign address notification packet is received, checking this timer when multicast packets addressed to the multicast group G's multicast address MCA (G) are received, and performing encapsulated forwarding if the timer is running.

Alternatively, the method of storing the time when the foreign address notification packet was received, and performing encapsulated forwarding if the difference between that time and the time when a multicast packet addressed to MCA (G) is received is within the encapsulated forwarding time period, and various other such methods, can be applied.

Furthermore, there is the method of having the HA 110 store the encapsulated forwarding time period uniformly or for each MN, or for each multicast group, or for each foreign subnetwork, etc.

Or one can have the MN 301 include and transmit time period designation information indicating the forwarding time period for instance in a BU message, and use this as the encapsulated forwarding time period.

When using a method whereby the MN 301 designates the encapsulated forwarding time period, such as the above-described method of including the encapsulated forwarding time period in MN 301's BU message, it is also possible, for instance, for the MN 301 to store, for each multicast group and/or for each foreign network, the time required until reception of multicast packets for a multicast group via the direct forwarding route after an earlier move, and notify HA 110 of this as the encapsulated forwarding time period.

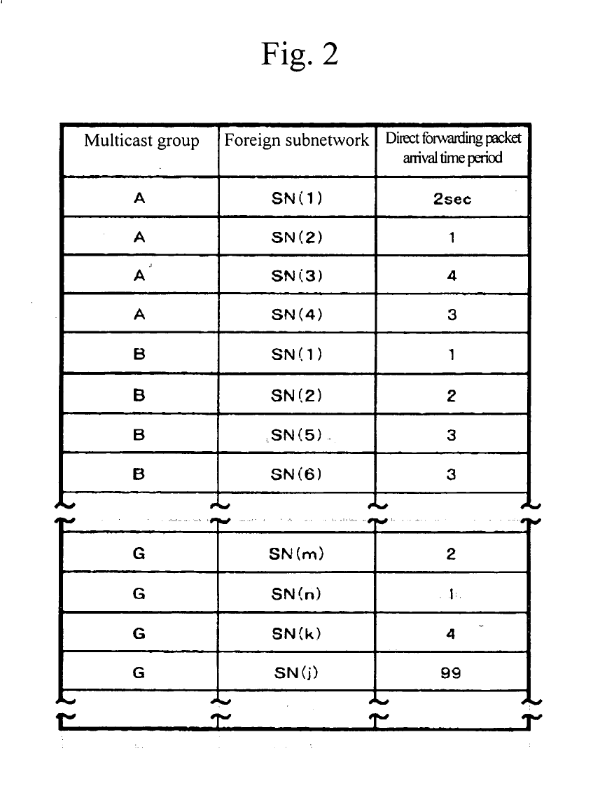

FIG. 2 is a drawing that shows an example of the packet arrival time period table that the mobile node MN 301 would have in such a case.

For example, if the MN 301 previously moved to subnetwork (m) while subscribed to multicast group G, it would store the time it took from immediately after the move until multicast packets for multicast group G were received via a direct forwarding route.

In the example of FIG. 2, G, which is the identifier of the multicast group, is stored in the Multicast group column; SN (m), which is the identifier of the foreign subnetwork moved to, is stored in the foreign subnetwork column; and the arrival time, e.g. 2 seconds, is stored in the direct forwarding packet arrival time period column.

Here, if the foreign subnetwork moved to does not have a multicast packet delivery function, i.e. if AR (2) 202 in FIG. 1 is not a multicast protocol compatible router, then MN 301 would store for instance 99, as information indicating that multicast packets should continue to be forwarded from HA 110, in the direct forwarding packet arrival time period column.

The MN can find out that there is no multicast router in a foreign subnetwork for instance based on the content of the router advertisement from the access router or based on the fact that there is no response to a join message to join the aforementioned multicast group.

When MN 301, with such a packet arrival time period table prepared, moves for instance to subnetwork (m) while subscribed to multicast group G, MN 301 will refer to this table and transmit the time period (2 seconds) stored in the direct forwarding packet arrival time period column to HA 110.

If HA 110 uses this time period as the encapsulated forwarding time period or adds a margin time period to this time period and uses the result as the encapsulated forwarding time period, it will be possible to set a suitable encapsulated forwarding time period for each foreign subnetwork and multicast group with a different forwarding tree configuration, making it possible to avoid unneeded encapsulated forwarding, i.e. to avoid wasting network resources, allowing packet loss to be reduced, and making it possible to efficiently improve data forwarding quality.

When the aforementioned specific data (e.g. 99) is received by HA 110 as the direct forwarding packet arrival time period, i.e. when HA 110 receives a notification indicating that MN 301 has moved to subnetwork with no multicast router, HA 110 continues to encapsulate and forward multicast packets addressed to MCA (G) to CoA (2).

One can also have this continued encapsulated forwarding to CoA (2) be stopped when HA receives a leave message indicating that MN 301 has left multicast group G, or when HA 110 receives a new BU message from MN 301.

By doing this, even if there is no multicast protocol compatible router in the foreign subnetwork to which MN 301 has moved, until MN 301 leaves the multicast group or moves to another subnetwork, MN 301 will be able to receive multicast packets of the multicast group it is subscribed to via the encapsulated forwarding route, unneeded encapsulated forwarding, i.e. wasting or network resources, can be avoided, packet loss can be reduced, and data forwarding quality can be efficiently increased.

Furthermore, one may optionally configure the packet processing unit 330 of MN 301 to have the function of a forwarding stop instruction means, which transmits forwarding stop instructions to HA 110 to stop encapsulated forwarding of multicast packets by HA 110.

In this case, MN 301 is configured so as to transmit the aforementioned forwarding stop instruction to HA 110 after MN 301 has transmitted a multicast group join request to AR (2) 202 and received multicast packets for the aforementioned multicast group based on said join request.

For example, if MN 301 transmits the encapsulated forwarding time period, its value would be transmitted as a specific value, for instance 0.

Upon receiving this, HA 110 will stop the processing whereby received multicast packets addressed to MCA (G) would be encapsulated and forwarded to CoA (2).

As a result, redundant packets will not be transmitted to MN 301, having the effect of preventing the wasting of network resources due to redundant packet transmission.

When MN 301 checks the packet arrival time period table and there is corresponding multicast group or foreign subnetwork, one can have it transmit a default value, i.e. 10 seconds, as the packet arrival time period to HA 110.

Furthermore, while the above embodiment example was described under the assumption that MN 301 participates in a single multicast group and that there is one sender 501, it is clear that the same effect is provided by the same arrangement also when MN 301 is participating in multiple multicast groups or when there are multiple senders.

Moreover, while the above embodiment example was described under the assumption that the access router connected to MN 301 doubles as the multicast router, the access router and multicast router may also be separate.

Furthermore, while in FIG. 1, the connection relationships between nodes, for instance between MN 301 and AR (1) 201 or between nodes and networks, were shown using straight lines, this connection indicates that the elements are in a connection relationship, regardless of whether it is a wired connection or wireless connection. The same is true for the drawings described below.

Moreover, in FIG. 1, there are cases where the packet network will contain many routers, and it is clear that the present invention can be applied in such cases as well.

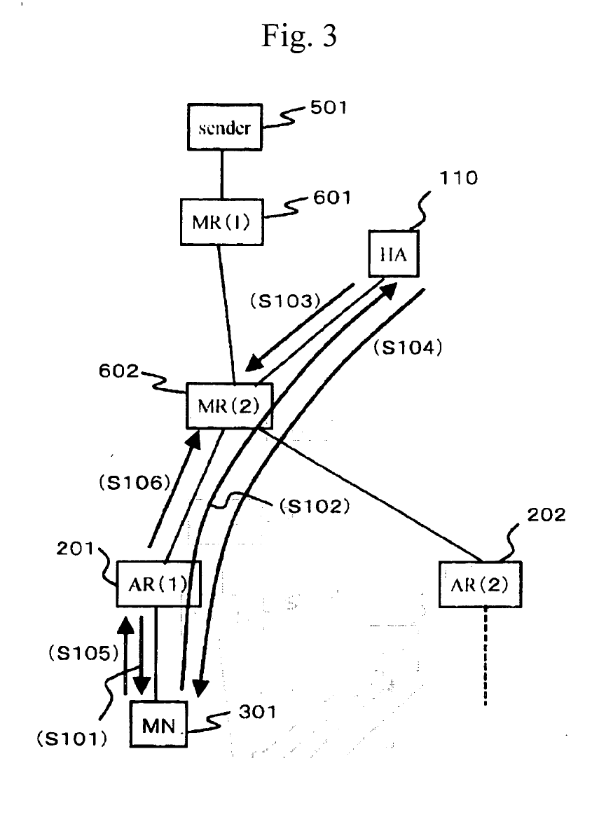

FIG. 3 is a drawing that explains a second embodiment example of the present invention and that illustrates the point in time when the mobile node MN 301 has initiated communication in the subnetwork to which the multicast protocol compatible access router AR (1) 201 belongs.

In FIG. 3, upon initiating communication in the subnetwork to which AR (1) 201 belongs, the mobile node MN 301 receives a router advertisement message transmitted by AR (1) 201. (S101)

Based on the information contained in the router advertisement message, MN 301 recognizes that AR (1) 201 is a multicast protocol compatible router and the designated router for this subnetwork.

Furthermore, MN 301 recognizes the subnetwork prefix contained in AR (1)'s router advertisement message and performs generation of the care-of address CoA (1) for this foreign network.

Next, MN 301 notifies the home agent HA 110 of its care-of address CoA (1), which is its current foreign address, i.e. performs location registration.

Taking the example of Mobile IP v6, a message called BU (Binding Update) is provided for the purpose of location registration. The basic information contained in a BU message is information indicating the correspondence between the mobile node's home address HoA, which is its base address in the home network to which it fundamentally belongs, and its care-of address CoA (1). However, in the present embodiment example, in addition thereto, a multicast compatible flag, which serves as an identifier indicating whether or not there is a router with a function of receiving and delivering multicast packets, i.e. a multicast protocol compatible router, in the current foreign subnetwork, and a leave flag, which serves as an identifier indicating the multicast group address MCA (G), as a specific address received by MN 301, and whether the multicast packets addressed to this address will be received or if reception is to be terminated, are included in the BU message and transmitted to HA 110. (S102) Here, the value of the multicast compatible flag is defined to be for instance “1” if the subnetwork is multicast protocol compatible and “0” otherwise, and the value of the leave flag is defined to be “0” if the MN is to newly subscribe to the notified multicast group address and “1” if it is to unsubscribe.

There may be multiple multicast groups to which MN 301 subscribes, in that case the method of transmitting a BU message containing multiple multicast group addresses and corresponding leave flags, the method of transmitting multiple BU messages containing the aforementioned information for each multicast group address, or the like, can be applied.

Upon receiving this BU message, HA 110 registers MN 301's home address HoA (1) and the corresponding care-of address CoA (1) in the binding cache, which serves as storage means for information about each mobile node.

Furthermore, in the present embodiment example, in addition what was described above, HA 110 likewise stores the multicast compatible flag for the foreign subnetwork of MN 301, the multicast group address MCA (G), and the corresponding leave flag in the binding cache.

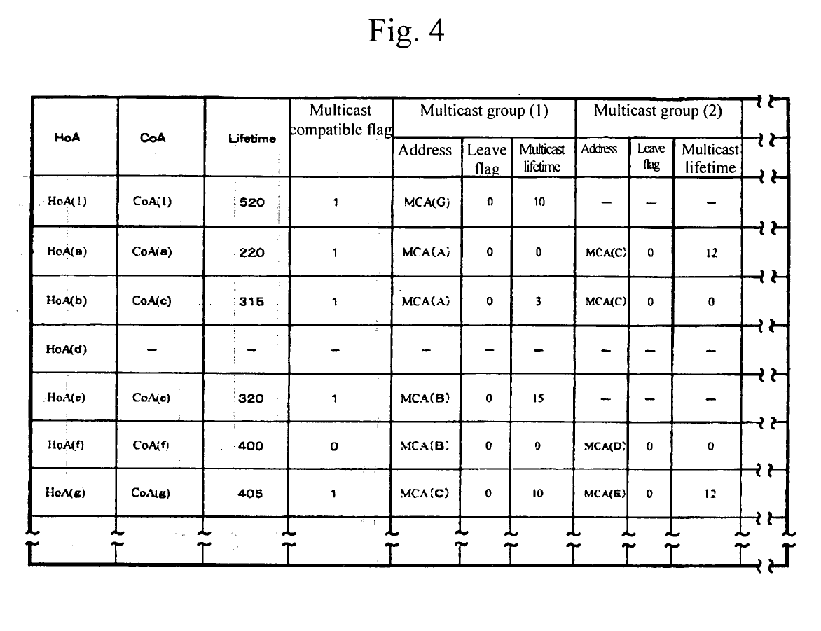

FIG. 4 is a drawing that shows an example of the content stored in the binding cache here.

In this example, in the row of HoA (1) corresponding to MN 301, the value of the multicast compatible flag is “1”, so the foreign subnetwork is multicast protocol compatible.

The leave flag corresponding to MCA (G) is “0”, indicating that the MN will subscribe to multicast group G.

Furthermore, in FIG. 4, the multicast lifetime indicates the time period for that encapsulated forwarding is to be carried out to CoA (1) for MN 301 when movement of MN 301 between subnetworks is detected, i.e. when a handover takes place, and is for instance a value decremented every second from the point in time when the handover took place.

Until this value becomes 0, HA 110 will forward received multicast packets addressed to the corresponding MCA (G) to the CoA address, for instance by encapsulating them.

The initial value of the multicast lifetime may be set by HA 110 itself, or may be notified by the MN by including it in a BU message. In the example of FIG. 4, 10 (seconds) has been set as the multicast lifetime of HoA (1) for MCA (G).

In FIG. 4, the lifetime in the case of Mobile IP v6 indicates the time period for that the CoA is valid and is a fundamental piece of information registered in the binding cache.

Furthermore, HA 110 is provided with and updates a multicast table that indicates that mobile nodes are subscribed to which multicast groups.

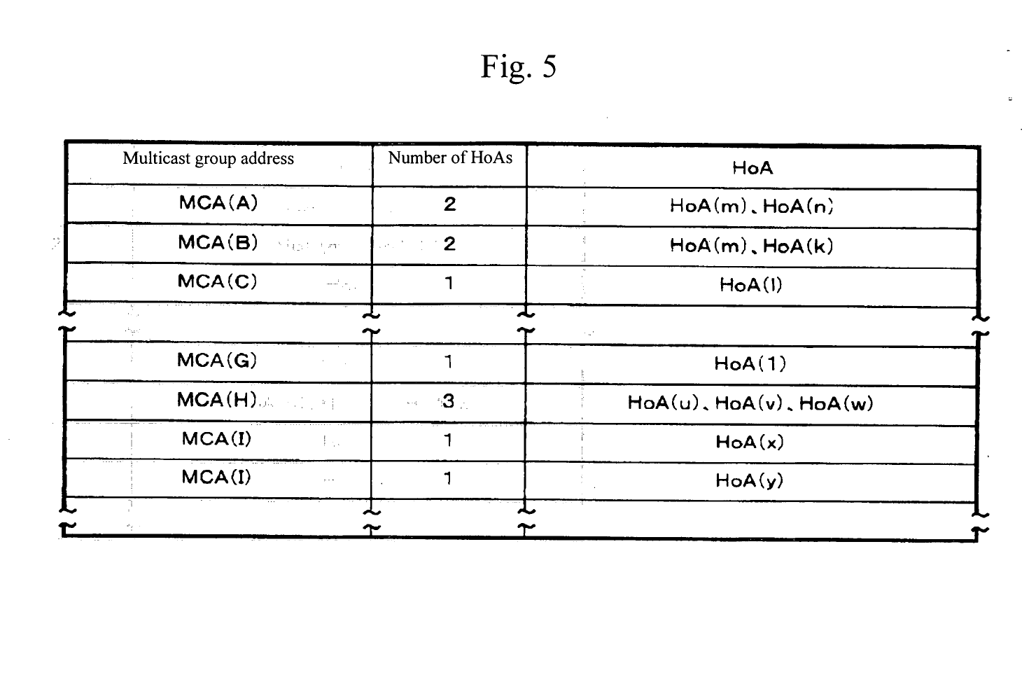

FIG. 5 is a drawing that shows an example of a multicast table.

In FIG. 5, based on information contained in the BU message from MN 301: the multicast group address and the fact that the corresponding leave flag is 0, indicating subscription, HA 110 stores HoA (1) in association with the multicast group address MCA (G). The HA can thus know that MN wishes to receives multicast packets for that multicast group.

For example, in FIG. 5, it can be seen that the mobile nodes corresponding to HoA (m) and HoA (k) are subscribed to multicast group B with address MCA (B).

Upon receiving a BU message with a leave flag indicating unsubscription from a multicast group, HA 110 performs an update of the multicast table. That is, it searches for the corresponding multicast group, deletes the HoA of the MN which transmitted the BU message, and maintains consistency of the information on MNs subscribed to the multicast group in question.

When creating a new entry in the aforementioned multicast table, since no branch of the forwarding tree corresponding to multicast group G has been extended yet to HA 110, HA 110 transmits a join message for MCA (G) to MR (2) 602, which is the designated router of HA 110 (S103) and request creation of a branch of the forwarding tree so that the multicast packets will reach HA 110. If a branch of the forwarding tree corresponding to multicast group G already extends to HA 110, for instance when a multicast group entry has already been created and an HoA is to be added to the same entry, transmission of the aforementioned join message is not necessary.

In this state, upon receiving a multicast packet addressed to MCA (G), transmitted from the sender 501, HA 110 refers to the multicast table and obtains the HoA of MNs desiring reception—in the example of FIG. 5, HoA (1) corresponding to MCA (G).

Then HA 110 checks the binding cache corresponding to HoA (1), obtains the CoA (1) of MN 301, and performs encapsulation and forwarding to CoA (1) of multicast packets addressed to MCA (G) that arrive at HA 110 until the value of the multicast lifetime becomes “0”. (S104)

MN 301 is able to receive multicast packets encapsulated to this CoA (1) for the period of the multicast lifetime, decapsulate them, and obtain the multicast packets addressed to MCA (G).

Meanwhile, MN 301 transmits a BU message to HA 110 and transmits a multicast group join message to the designated router DR to request creation of a branch of the forwarding tree.

In the example of FIG. 3, MN 301 transmits a join message for multicast group G to the access router AR (1) 201, which doubles as the designated router. (S105)

Having receiving this join message, AR (1) 201, if there is no branch of the forwarding tree for multicast group G extending to it, transmits a join message to the higher level designated router MR (2) and requests that a branch of the forwarding tree of multicast group G be extended to itself. (S106)

When MN 301 initiates communication by the above operations while attached to the subnetwork of AR (1) 201, it will receive multicast packets addressed to MCA (G) via the encapsulated forwarding route from HA 110 only for the period of the initial value set as the multicast lifetime.

Consequently, even if there is no branch of the forwarding tree for multicast group G extending to AR (1) 201, and a long time is required to create a branch of the forwarding tree and it takes MN 301 several seconds to initiate reception via the direct forwarding route, it will still be able to receive via the encapsulated forwarding route, making it possible to shorten the time from when MN 301 initiates communication in the subnetwork of AR (1) 201 until it receives multicast packets it is subscribed to.

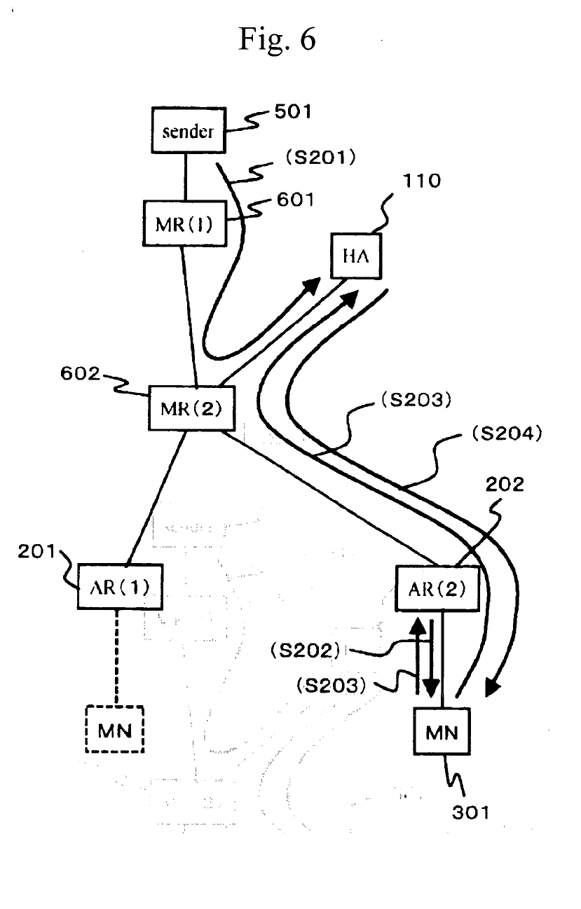

FIG. 6 is a drawing (2) that describes the second embodiment example of the present invention and that illustrates the point in time when the mobile node MN 301 has moved to the subnetwork of multicast protocol compatible access router AR (2) 202 while receiving multicast packets of multicast group (G).

As described for FIG. 3, at this point in time, there is a branch of the forwarding tree for multicast group G extending to HA 110, and multicast packets addressed to MCA (G) are being received. (S201)

In FIG. 6, when MN 301 moves to the subnetwork of AR (2) 202, MN 301 receives the router advertisement message transmitted by AR (2) 202, just as when initiating communication in the subnetwork of AR (1) 201. (S202)

From the information contained in the router advertisement message, MN 301 recognizes that AR (2) 202 is a multicast protocol compatible router and the designated router for this subnetwork, creates the care-of address CoA (2) in the same manner, and transmits it together with the multicast compatible flag, multicast group address MCA (G) and leave flag in a BU message to HA 110. (S203)

Having received this BU message, HA 110 rewrites the content of the binding cache corresponding to MN 301, i.e. HoA (1), and resets the multicast lifetime value to 10 seconds.

In the example of FIG. 4, HA 110 rewrites the CoA value for HoA (1) from CoA (1) to CoA (2) and sets the initial value of the multicast lifetime at 10 seconds.

HA 110 will consequently encapsulate and forward multicast packets addressed to MCA (G) to the care-of address CoA (2) of MN 301 for a period of 10 seconds from the time of receiving the BU message from MN 301 (S204), making it possible to reduce loss of packets addressed to the multicast group due via the direct forwarding route that is interrupted for a time during handover, and allowing data forwarding quality to be improved.

Furthermore, if there is no multicast protocol compatible router in the foreign subnetwork, for instance if AR (2) 202 is not multicast protocol compatible, MN 301 will transmit a BU message to HA 110 with the multicast compatible flag set to “0”.

Having received this, HA 110 will encapsulate and forward received multicast packets addressed to MCA (G) to CoA (2) regardless of the set value of the multicast lifetime.

In this way, even when there is no multicast protocol compatible router and multicast packets addressed to MCA (G) cannot be received via the direct forwarding route, MN 301 can receive these packets via the encapsulated forwarding route, making it possible to improve data forwarding quality.

It is also possible to implement a method whereby the BU message transmitted by MN 301 is transmitted to the pre-move AR, or to AR (1) 201 in FIG. 6, and encapsulated forwarding is done from the pre-move AR to the current CoA.

Furthermore, while in the above description, the use of multicast lifetime was assumed, it is similarly possible to implement a method whereby MN 301 notifies HA 110 of its own multicast packet reception state and HA 110 decides whether or not to do encapsulated forwarding accordingly.

This is effective, for instance, if the MN monitors the state of multicast packet reception via the direct forwarding route, and if it is deemed to be poor, requests packet forwarding via the encapsulated forwarding route from the HA, reducing packet loss and making it possible to improve data forwarding quality.

Moreover, while in the present embodiment example, the method whereby MN 301 determines whether AR (1) 201 and AR (2) 202 are multicast protocol compatible routers or not was assumed to involve including this information in the router advertisement message transmitted by each AR, is only one example. Other methods include the method whereby the MN transmits a multicast group join message in a foreign subnetwork, waits for the response, and if there is no response for a set period of time, deems it to be not multicast protocol compatible.

In this case, a set period of time is needed for the MN to judge whether or not the AR is a multicast protocol compatible router after moving, so the technique of the present invention becomes more efficient.

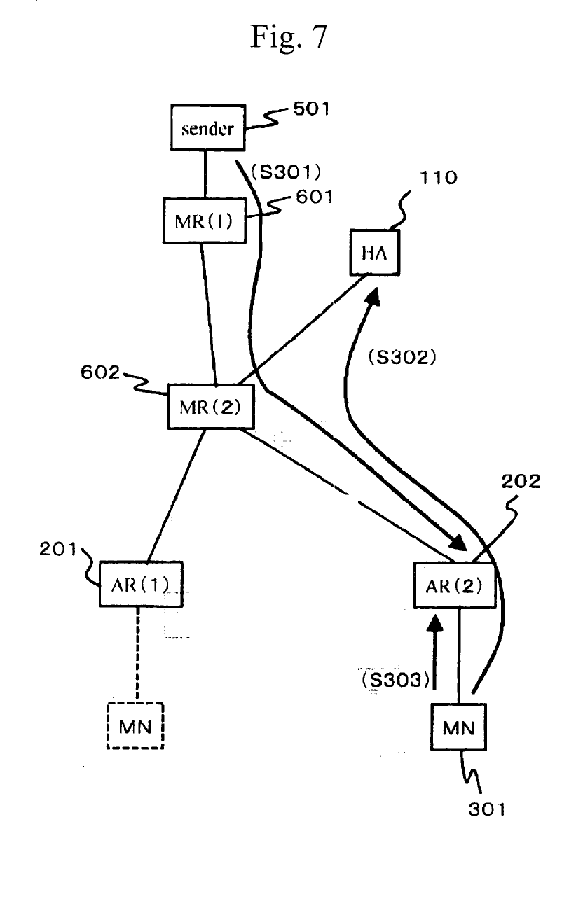

FIG. 7 is a drawing (3) that describes the second embodiment example of the present invention.

In FIG. 7, it is assumed that the foreign multicast router AR (2) 202 already has a branch of the forwarding tree for multicast group G created to it, and that multicast packets addressed to MCA (G) are received at AR (2) 202. (S301)

In this case, MN 301 becomes able to receive multicast packets immediately upon transmitting a join message to AR (2) 202.

Normally, the MN cannot know whether or not a branch of the forwarding tree for a multicast group the MN is subscribed to has been extended to a foreign AR until it connects to which AR. In the present embodiment example, as described above, a location registration or BU message is transmitted to the HA, transferring parameters for multicast forwarding contained therein and requesting encapsulated forwarding. (S302)

If a branch of the forwarding tree for multicast group G has already been extended to AR (2) 202, which is the multicast protocol compatible router at the foreign location of MN 301, then MN 301 will be able to receive multicast packets immediately via the direct forwarding route upon transmitting a join message to AR (2) 202. (S303)

For MN 301, once it receives non-encapsulated multicast packets, the encapsulated packets forwarded by HA 110 become unnecessary redundant packets.

In multicast applications that process the multicast packets received by MN 301, the reception of such redundant packets will not have much effect since unnecessary packets will be discarded, but stopping unnecessary encapsulated forwarding from HA 110 is effective for preventing the wasting of network resources.

The method of stopping encapsulated forwarding from HA 110 in the present embodiment example is described below.

When encapsulated forwarding becomes unnecessary, MN 301 again performs location registration, i.e. transmits a BU message to HA 110, with the multicast lifetime set to 0. At HA 110, the reception of this BU message causes the multicast lifetime contained in its binding cache to become “0”, which makes it possible to stop subsequent encapsulated forwarding of multicast packets addressed to MCA (G) and to prevent wasting of network resources.

Furthermore, other methods of finding out whether or not a branch of the forwarding tree for a multicast group that the MN is subscribed to has been extended to the MN's foreign multicast router include the following.

Namely, there is the method of including information on multicast groups currently being handled by the AR in the router advertisement message that the AR transmits. In this case, right after moving, MN 301 can judge whether or not a branch of the forwarding tree for multicast groups that MN 301 has been receiving has been created to AR (2) 202 where it has moved, so the encapsulated forwarding of multicast packet by HA 110 can be stopped by transmitting “0” as the initial value of the multicast lifetime from the outset in the BU message transmitted to HA 110 right after moving.

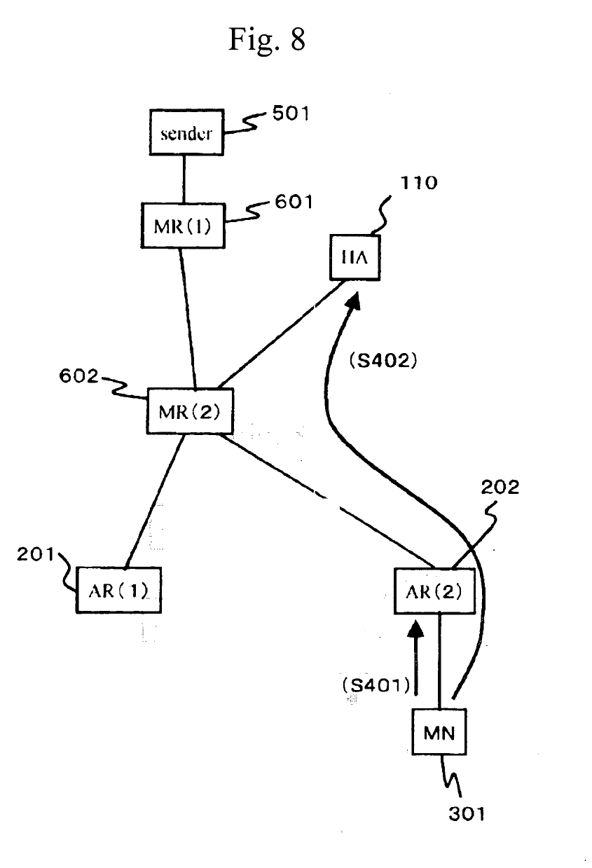

FIG. 8 is a drawing (4) that describes the second embodiment example of the present invention, describing the operation in the case where an MN unsubscribes from a multicast group and stops receiving the corresponding multicast packets.

To stop reception of multicast packets via the direct forwarding route, MN transmits a leave message to AR (2) 202. (S401)

Having received the leave message, AR (2) 202 stops transmission of the corresponding multicast packets if there are no other receivers in the corresponding multicast group.

Furthermore, to stop reception of multicast packets via encapsulated forwarding route, a BU message is transmitted to HA 110, containing the multicast group address to be stopped, a leave flag with its value set to “0”, indicating unsubscription, and a multicast lifetime with its value set “1”. (S402)

Having receiving this BU message, HA 110 updates the binding cache corresponding to MN 301, and also updates the multicast table, since the value of the leave flag is “1”.

For the binding cache, the corresponding multicast group address is deleted, the value of the leave flag is set to e.g. null, and the value of multicast lifetime is set to e.g. null.

For the multicast table, the corresponding multicast group address is searched for and the sender HoA (1) is deleted.

Upon receiving multicast packet addressed to MCA (G) in this state, HA 110 will not perform encapsulated forwarding of the multicast packet to MN 301, since HoA (1) is not registered in the multicast table.

In FIGS. 3, 6, 7 and 8, it is clear that the present invention is also applicable and that the effect describe above can be obtained if there many routers between the sender 501 and AR(1) 201 and AR (2) 202 or between the sender 501 and HA 110.

Next, a third embodiment example of the present invention will be described.

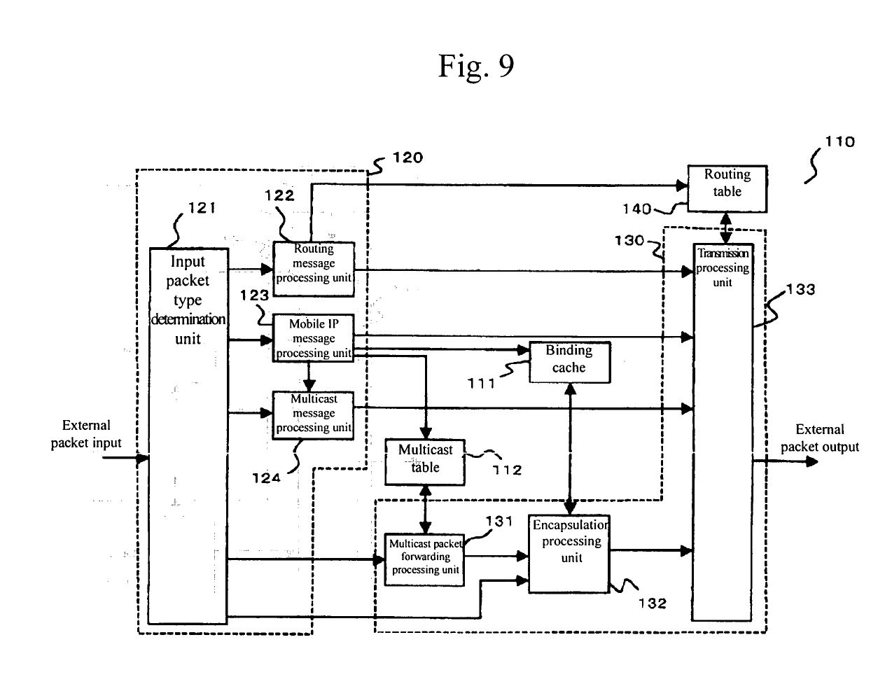

FIG. 9 is a drawing that shows an example of the constitution of a home agent (HA).

In FIG. 9, HA 110 consists of an input packet type determination unit 121, routing message processing unit 122, mobile IP message processing unit 123, multicast message processing unit 124, multicast packet forwarding processing unit 131, encapsulation processing unit 132, transmission processing unit 133, routing table 140, binding cache 111 and multicast table 112.

The input packet type determination unit 121 analyzes the header information of packets inputted from outside and directs them to the appropriate processing unit.

If the input packet is a RIP or other routing protocol message, then the packet is directed to the routing message processing unit 122, and the results of the routing message processing are reflected in the routing table 140.

If the input packet is a mobile IP message, the packet is directed to the mobile IP message processing unit 123 and the results of its processing are reflected in the binding cache 111 and multicast table 112.

If the input packet is a multicast protocol message, the packet is directed to the multicast message processing unit 124, and the results are reflected in the multicast table 112.

If the input packet is a normal packet addressed to an MN, then the destination address will be HoA. In this case, the packet is directed to the encapsulation processing unit 132, encapsulation is performed using the CoA obtained as a result of consulting the binding cache corresponding to the HoA in question, and the output interface is determined and the packet is outputted to the outside by the transmission-processing unit 133.

If the input packet is a multicast packet addressed to a multicast group, the packet is directed to the multicast packet forwarding processing unit 131. The multicast packet forwarding processing unit 131 searches the multicast table 112 using the destination IP address of the arriving packet as the key and finds if there is an HoA registered corresponding to this multicast group.

The binding cache 111 corresponding to the HoA obtained here is searched, and the CoA obtained as a result of that search is uses as the destination address by the encapsulation processing unit 132 to perform encapsulation processing, and an encapsulate packet is outputted.

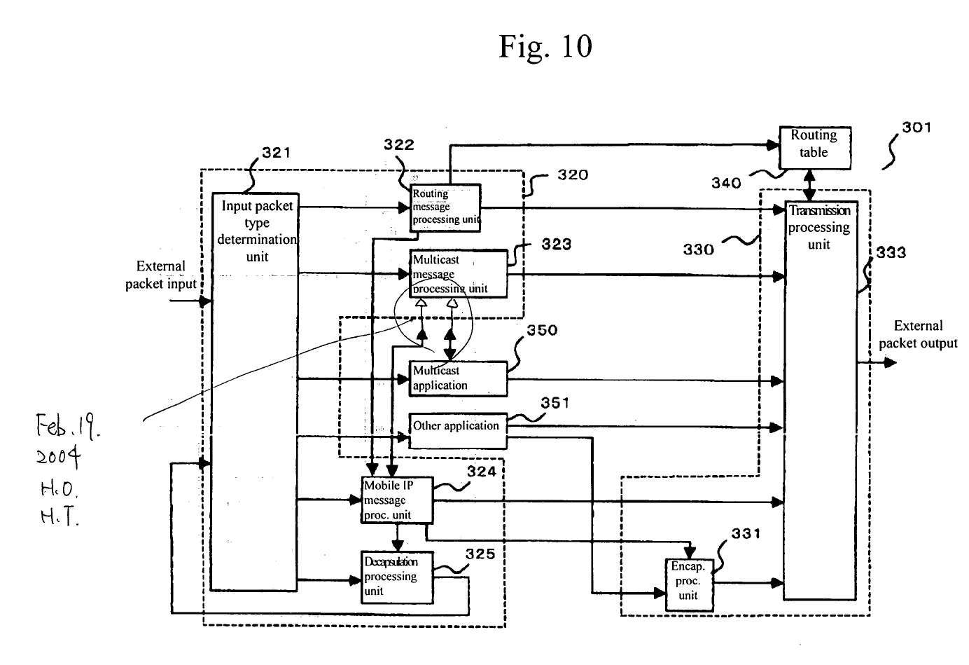

If multiple HoA's are registered in the multicast table, the aforementioned multicast packet is copied for each HoA, encapsulation processing is performed by the encapsulation processing unit 132 using the CoA corresponding to each HoA as the destination address, and the encapsulated packets are outputted. FIG. 10 is a drawing that shows an example of the constitution of the mobile node (MN).

In FIG. 10, MN 301 consists of an input packet type determination unit 321, routing message processing unit 322, mobile IP message processing unit 323, multicast message processing unit 324, decapsulation processing unit 325, encapsulation processing unit 331, transmission processing unit 333, routing table 340, multicast application 350 and other application 351.

The input packet type determination unit 321 analyzes the header information of packets inputted from outside and directs them to the appropriate processing unit.

If the input packet is a RIP or other routing protocol message, then the packet is directed to the routing message processing unit 322, and the results of the routing message processing by the routing message processing unit 322 are reflected in the routing table 340.

If the input packet is a multicast protocol message, the packet is directed to the multicast message processing unit 323. Multicast message processing unit 323 issues a join message to the foreign AR based on instructions from the multicast application 350. Furthermore, a join message is issued right after the MN carries out a move.

If the input packet is a packet addressed to a multicast group, the packet is directed to the multicast application 350.

If the input packet is a mobile IP message, the packet is directed to the mobile IP message processing unit 324. The results of the processing of this message are reflected to the decapsulation processing unit 325 and the encapsulation processing unit 331.

The encapsulation processing unit 331 is a block used when it is necessary to perform encapsulation addressed to the HA (called a reverse tunnel). Furthermore, the decapsulation processing unit 325 is a block that decapsulates encapsulated packets forwarded to the CoA.

If the input packet is a data packet addressed to the CoA, the packet is first directed to the decapsulation processing unit 325, where it is decapsulated to extract the original packet (hereinafter referred to as inner packet).

Then, as shown in FIG. 10, it is inputted into the input packet type determination unit and redirected according to the destination address of the inner packet.

If the destination of the inner packet is a multicast group address, it is directed to the multicast application 350. Furthermore, if the destination of the inner packet is the HoA, it is directed to the other application 351.

When transmitting packets using a reverse tunnel, the other application 351 transmits packets via the encapsulation processing unit 331 in order to carry out encapsulated forwarding.

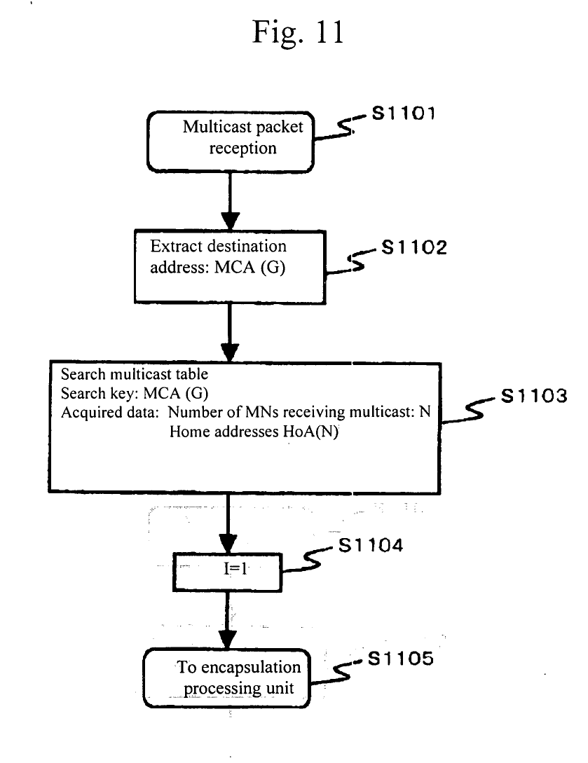

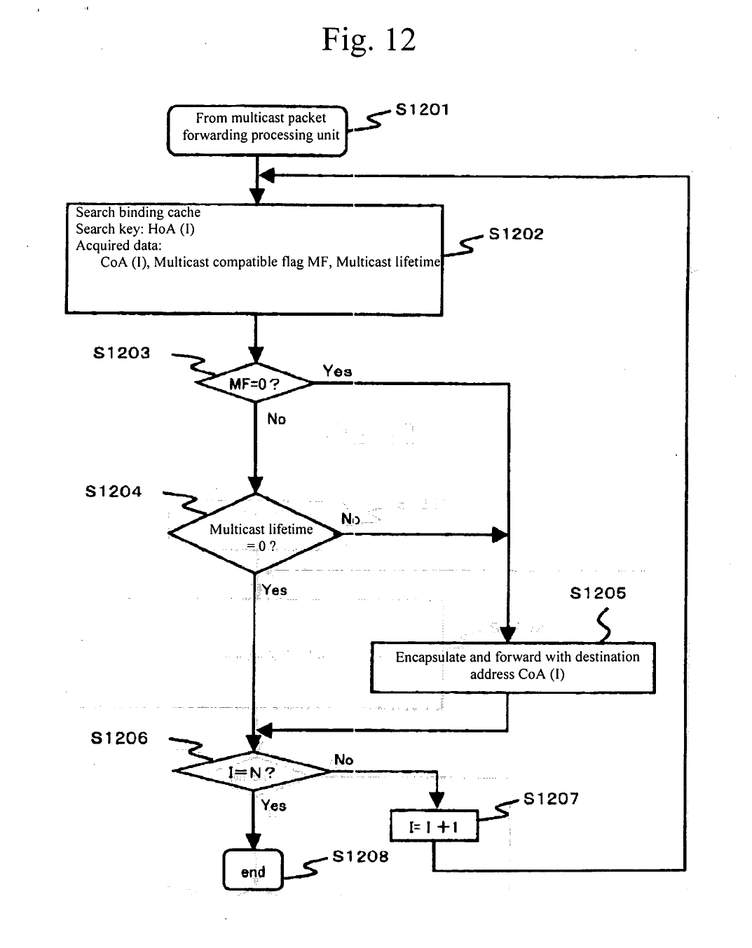

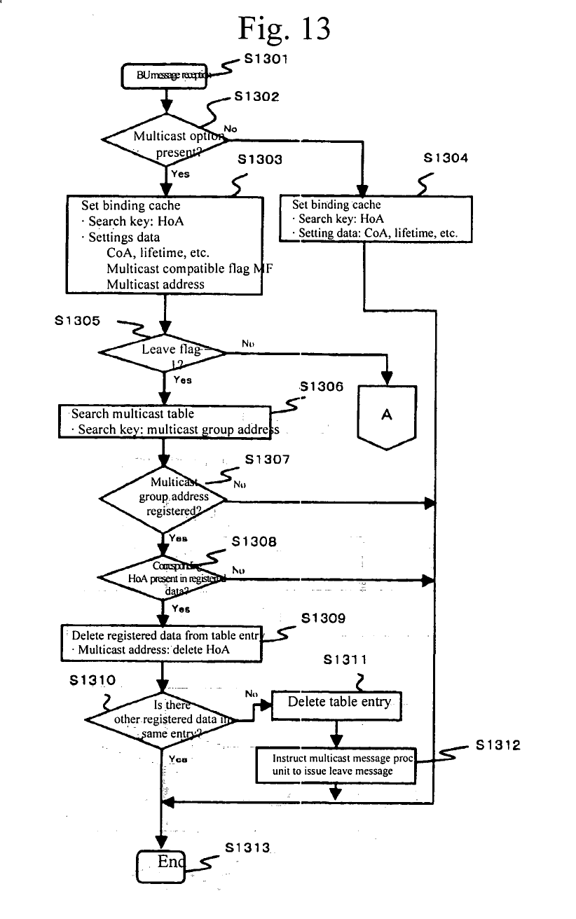

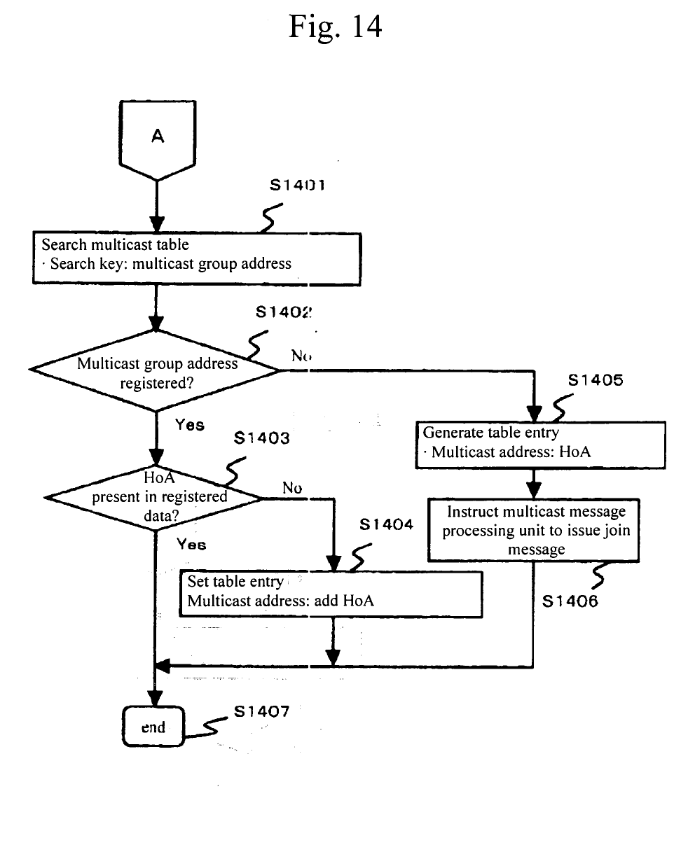

FIG. 11 is a flow chart of the multicast packet forwarding processing unit 131 in the example configuration of the home agent HA 110 shown in FIG. 9, FIG. 12 is a flowchart of the encapsulation processing unit 132, FIG. 13 is a flow chart (1) of the mobile IP message processing unit 123 and FIG. 14 is a flow chart (2) of the mobile IP message processing unit 123.

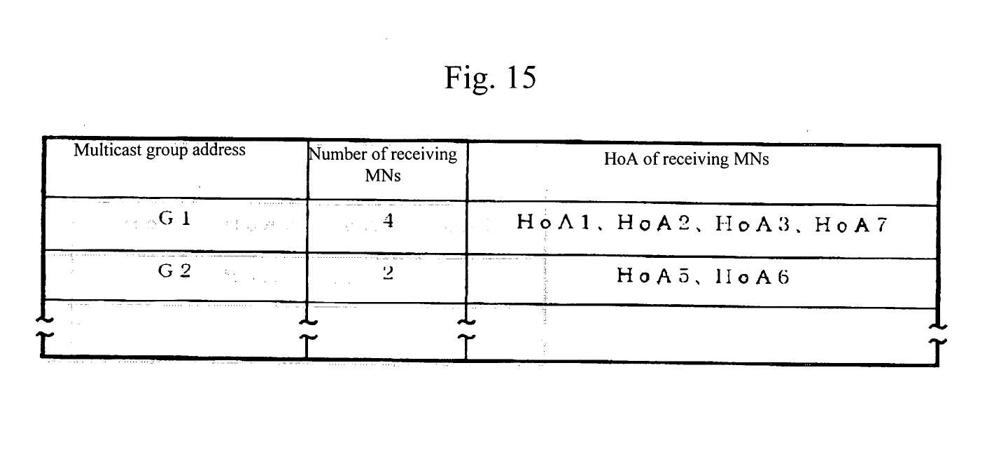

Furthermore, FIG. 15 is a drawing that shows an example configuration of the multicast table of HA 110.

Here, in FIG. 15, the multicast table holds the number of receiving MN addresses and their HoAs for each multicast group address.

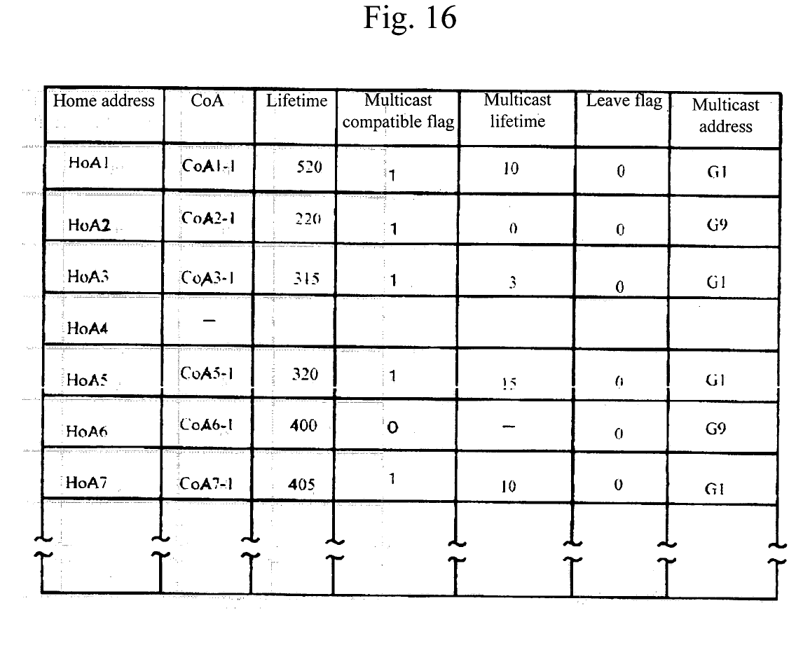

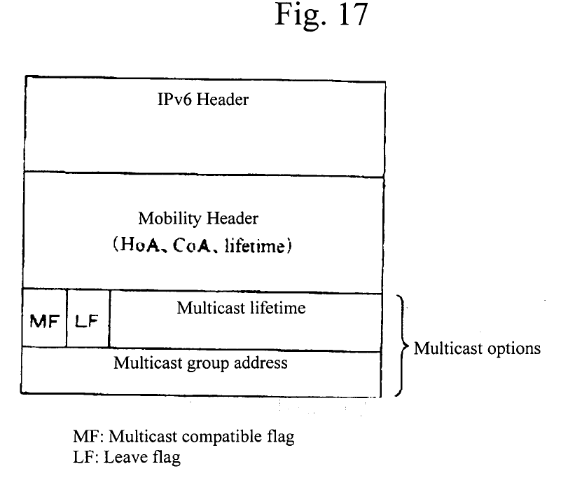

Moreover, FIG. 16 is a drawing that shows an example configuration of the binding cache of the HA, and FIG. 17 shows an example configuration of a BU message.

This example, in which a multicast option is added as an extension option field to the mobility header used in Mobile IP v6, is an example for notifying HA 110 of the multicast compatible flag MF and leave flag LF, and the multicast lifetime and multicast group address.

While the present embodiment example is an example where the MN 301 provides notification of the multicast lifetime, the multicast lifetime may also be set as a fixed value by the HA 110.

As shown in FIG. 11 and FIG. 12, when packets addressed to a multicast group arrive at HA 110 (S1101), the multicast table illustrated in FIG. 15 is extracted (S1102) and searched to obtain the number of MNs wishing to receive on this multicast group address and their HoAs (S1103).

Here, in order to repeat the processing as many times as there are MNs, a variable I is provided and initialized (S1104), and the system moves to the processing at the encapsulation processing unit (S1105; S1201 of FIG. 12).

Using the results of this, as shown in FIG. 12, the binding cache illustrated in FIG. 16 is searched for each HoA. (S1202)

As a result, if the foreign AR is multicast protocol incompatible (if the decision in S1203 is Yes), or if it multicast protocol compatible but the multicast lifetime decremented from the time of registration of the initial value is still within the period of validity (if the decision in S1204 is No), then encapsulated forwarding is carried out to the CoA. (S1205)

Otherwise, encapsulated forwarding is not carried out. Then, for all the HoAs obtained as a result of searching the multicast table 112 (S1206), this processing is carried out (S1207), and then the processing is terminated (S1208).

Doing this makes it possible to perform encapsulated forwarding of multicast packets to the MN only for a specific period of time right after a move, i.e. for the time period until the value of the multicast lifetime becomes 0. Furthermore, this makes it possible to perform encapsulated forwarding when the foreign subnetwork is not multicast protocol compatible.

As shown in FIG. 13, upon receiving a BU message (S1301), HA 110 operates differently depending on whether the BU message contains a multicast option.

If there is no multicast option (if the decision in S1302 is No), then the BU message is processed by the normal mobile IP procedure for unicast packets (S1304).

If there is a mobile option (if the decision in S1302 is Yes), then the binding cache 111 is set in accordance with the content of that option. (S1303)

Furthermore, the leave flag is checked, and if it has a value indicating unsubscription from a multicast group, for instance if it is 1 (if the decision in S1305 is Yes), then operations are carried out to delete the multicast related information.

That is, the multicast table 112 is searched (S1306), and the HoA that is terminating multicast communication is deleted from the corresponding entry. (S1309) Here, if, as a result of the deletion, the number of HoAs registered in the multicast group becomes 0 and there is no other data registered in the entry for this multicast group (if the decision in S1310 is No), then this table entry is deleted (1311) and the multicast message processing unit 124 is instructed to issue a leave message in order to delete the branch of the forwarding tree for the multicast group in question extending to HA 110. (S1312)

If the result of searching the multicast table is that there is no corresponding multicast group address found (if the decision in S1307 is No), or if there is no corresponding HoA (if the decision in S1308 is No), then processing is terminated. (S1313)

If the leave flag contained in the BU message is not a value indicating unsubscription from the multicast group, e.g. if it is 0 (if the decision in S1305 is No), then a corresponding entry is added to the multicast table.

Here, first the multicast table 112 is searched using the multicast group address contained in the BU message as a key. (S1401 of FIG. 14)

If the multicast group address has already been registered from processing other MNs (if the decision in S1402 is Yes) and the current HoA has not been registered (the decision in S1403 is No), then the current HoA is newly added and registered in the corresponding entry (S1404) and processing is terminated (S1407), and if the current HoA has already been registered (the decision in S1403 is Yes), then processing is terminated without further action (S1407).

If the multicast group address has not been registered (if the decision in S1402 is No), then the entry itself is added, the HoA is registered (S1405), and the multicast message processing unit 124 is instructed to issue a join message in order to create a branch of the forwarding tree for this multicast group to HA 110. (S1406)

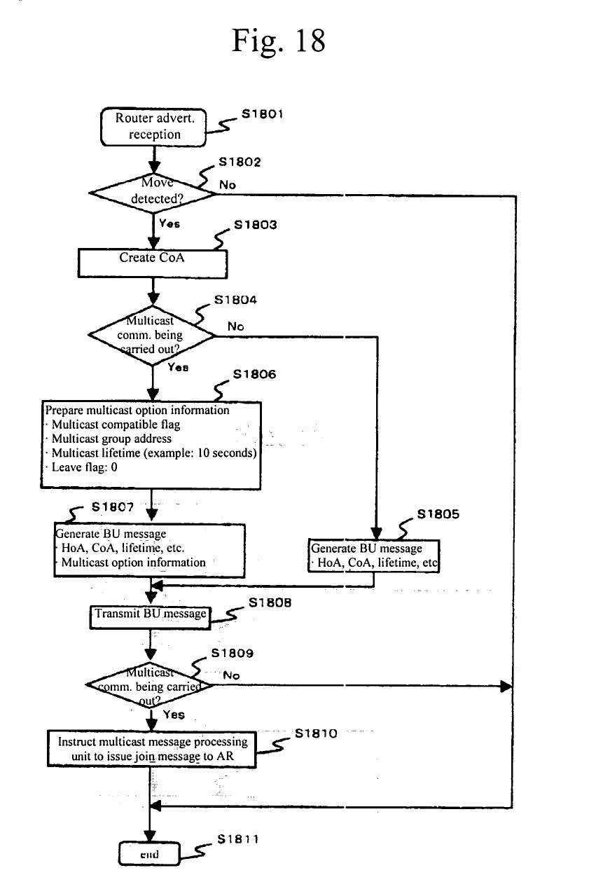

FIG. 18 is a flow chart of the operation at the time of moving of the mobile IP message processing unit 324 in the example configuration of the MN shown in FIG. 10.

As shown in FIG. 18, MN 301 receives a router advertisement (S1801) and determines if it itself has moved or not. Specifically, if there was a change in the router subnet prefix contained in the router advertisement, then it is judged that a move took place (the decision in S1802 is Yes), otherwise it is judged that no move has taken place (the decision in S1802 is No).

If it is judged that no move took place, processing is terminated. (S1811)

If it is judged that a move took place, first a CoA is created based on the aforementioned subnet prefix. (S1803)

Then a BU message to be sent to the HA is generated, and if the node is currently carrying on multicast communication (if the decision in S1804 and S1809 is Yes), then a multicast compatible flag and multicast group address, and the corresponding multicast lifetime (e.g. 10 seconds) and leave flag (e.g. 0, indicating subscription) are prepared as the multicast option information. (S1806)

Next, a BU message is generated (S1807) along with the HoA, CoA, lifetime, etc., which is the basic information of the mobile node, and is transmitted to HA 110. (S1808)

Furthermore, the multicast message processing unit is instructed to issue a join message to the AR (S1810), and processing is terminated (S1811).

If the node is not currently carrying on multicast communication (if the decision in S1804 and S1809 is No), then a BU message is generated (S1805) using the HoA, CoA, lifetime, etc., which is the basic information of the mobile node and is transmitted to HA 110 (S1808), and processing is terminated (S1811).

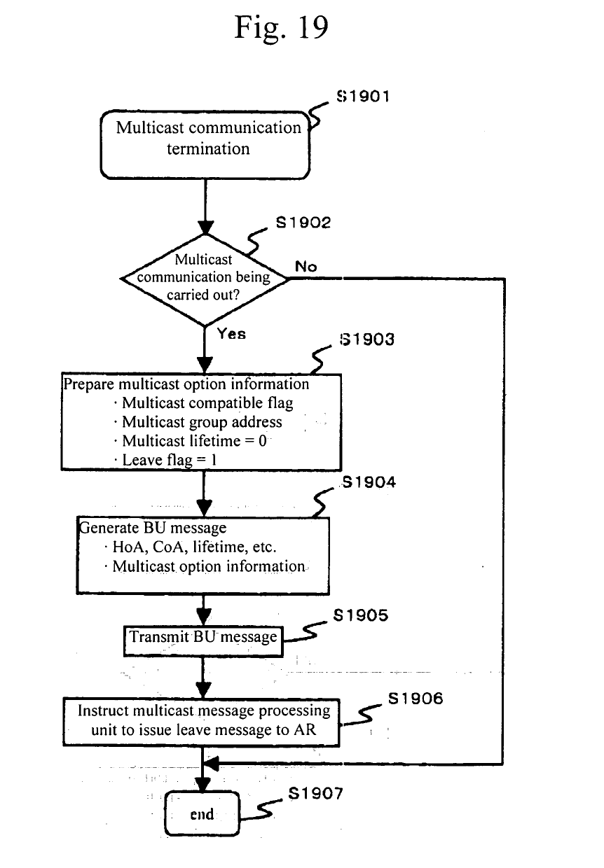

FIG. 19 is a flow chart of the operation at the time of terminating communication of the mobile IP message processing unit in the example configuration of then MN shown in FIG. 10.

As shown in FIG. 19, when terminating multicast communication (S1901), it is checked whether multicast communication is being currently carried out, and if multicast communication is not currently being carried out (if the decision in S1902 is No), processing is terminated (S1907).

If multicast communication is currently being carried out (if the decision in S1902 is Yes), then multicast option information is prepared by setting the leave flag to e.g. 1, signifying unsubscription, along with the multicast compatible flag, multicast group address and multicast lifetime. (S1903)

Next, a BU message is generated, including the HoA, CoA, lifetime, etc., as the basic information of the mobile node (S1904), and is transmitted to HA 110 (S1905).

Furthermore, the multicast message processing unit is instructed to issue a leave message to the AR (S1906), and processing is terminated (S1907).

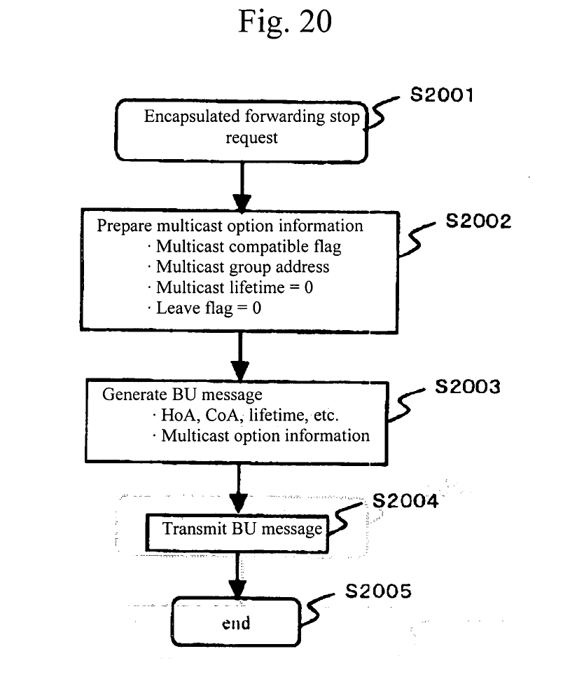

FIG. 20 is flow chart for stopping redundant encapsulated forwarding of the mobile IP message processing unit 324 in the example configuration of a MN shown in FIG. 10.

For instance, if forwarding of multicast packets via a direct forwarding route is started while receiving multicast packets via an encapsulated forwarding route, then the packets coming via the encapsulated forwarding route become redundant. The procedure whereby the MN stops forwarding of packets via the encapsulated forwarding route in such a case is shown in FIG. 20.

In FIG. 20, when requesting stoppage of encapsulated forwarding (S2001), multicast option information is prepared with the multicast lifetime set to 0 (S2002), a BU message is generated (S2003) and is transmitted to HA 110 (S2004), and processing is terminated (S2005).

In this way, in the present embodiment example as well, when multicast packets addressed to MCA (G) are received and the foreign subnetwork is multicast protocol compatible, HA 110 will encapsulate and forward multicast packets addressed to MCA (G) to the care-of address CoA (2) of MN 301 for the period of the multicast lifetime from the time the BU message is received from MN 301, making it possible to reduce loss of packets addressed to the multicast group via the direct forwarding route that is interrupted for a time upon handover, and allowing data forwarding quality to be improved.

Furthermore, if the foreign subnetwork is not multicast protocol compatible, HA 110 will continue to encapsulate and forward multicast packets addressed to MCA (G) to the care-of address CoA (2) of MN 301 from the time the BU message from MN 301 is received, making it possible to reduce the loss of packets addressed to the multicast group and to improve data forwarding quality.

Moreover, by reducing redundant encapsulated forwarding, there is the effect of avoiding wasting of network resources.

Next, a fourth embodiment example of the present invention will be described.

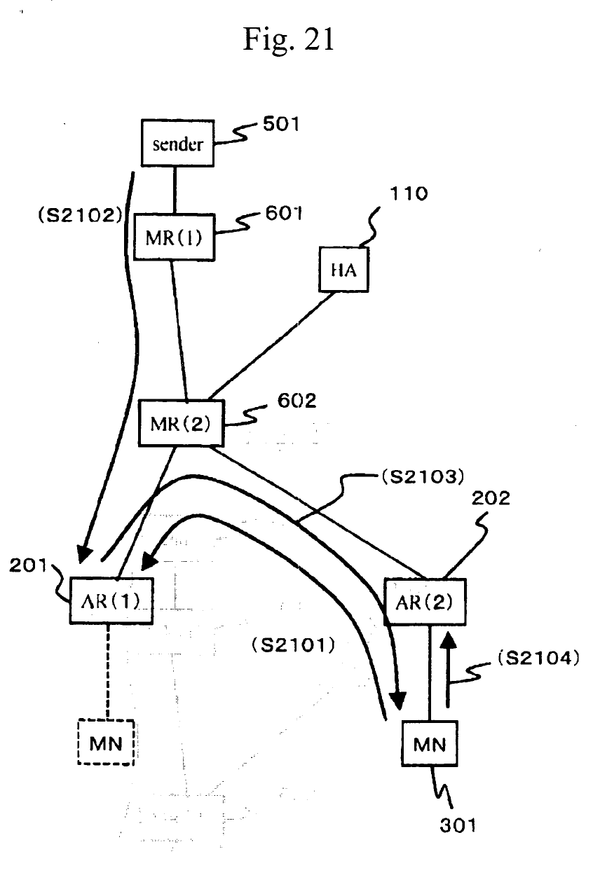

FIG. 21 is a drawing (1) that describes the fourth embodiment example of the present invention.

FIG. 21 illustrates an example of preventing the loss of multicast packets during a move by issuing a forwarding instruction, immediately after the move, to AR (1) 201, which is the old AR that was used before the move.

Immediately after moving to the subnetwork of AR (2) 202, MN 301 transmits a BU message to HA 110, notifying it, by means of the BU message, of the oldCoA, which is the old CoA that had been used with the old AR (AR (1) 201) before the move, and the newCoA, which is the new CoA that is generated from the subnet prefix of the new AR (AR (2) 202) and is to be used from now on. (S2101)

Moreover, when MN 301 moves from the subnetwork of AR (1) 201 to the subnetwork of AR (2) 202 while receiving packets addressed to MCA (G) via a direct forwarding route, since a branch of the forwarding tree for MCA (G) has already been created to AR (1) 201, reception of multicast packets addressed to MCA (G) is already possible. (S2102)

Upon receiving the BU message, the old AR (1) 201 performs the same operation with the HA as shown in the third embodiment example, whereby received multicast packets addressed to MCA (G) are encapsulated and forwarded to the new address, newCoA. (S2103)

Then, just as in the third embodiment example, MN 301 transmits a join message to AR (2) 202. (S2104)

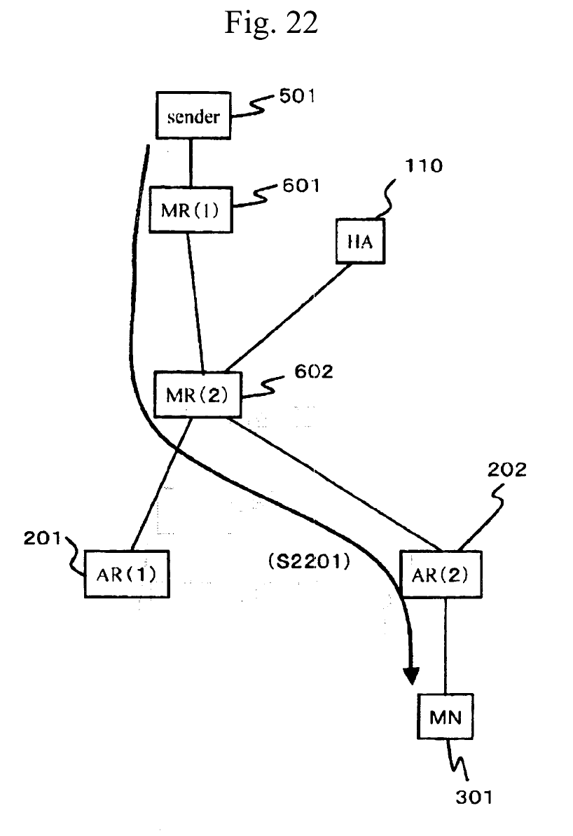

FIG. 22 is a drawing (2) that illustrates the fourth embodiment example of the present invention and shows the steady state after the MN has moved.

In FIG. 22, upon receiving the aforementioned join message, AR (2) 202 transmits a join message to the higher level DR if necessary, creates a branch of the forwarding tree for MCA (G) to itself, and transmits packets addressed to MCA (G) via a direct forwarding route to MN 301 using a multicast routing protocol, and MN 301 receives those packets. (S2201)

In this way, until MN 301 starts to steadily receive packets addressed to MCA (G) via the direct forwarding route, as shown in FIG. 22, it can receive them via the encapsulated forwarding route shown in FIG. 21, making it possible to reduce loss of packets addressed to the multicast group coming via the direct forwarding route that is interrupted for a time upon handover, and allowing data forwarding quality to be improved.

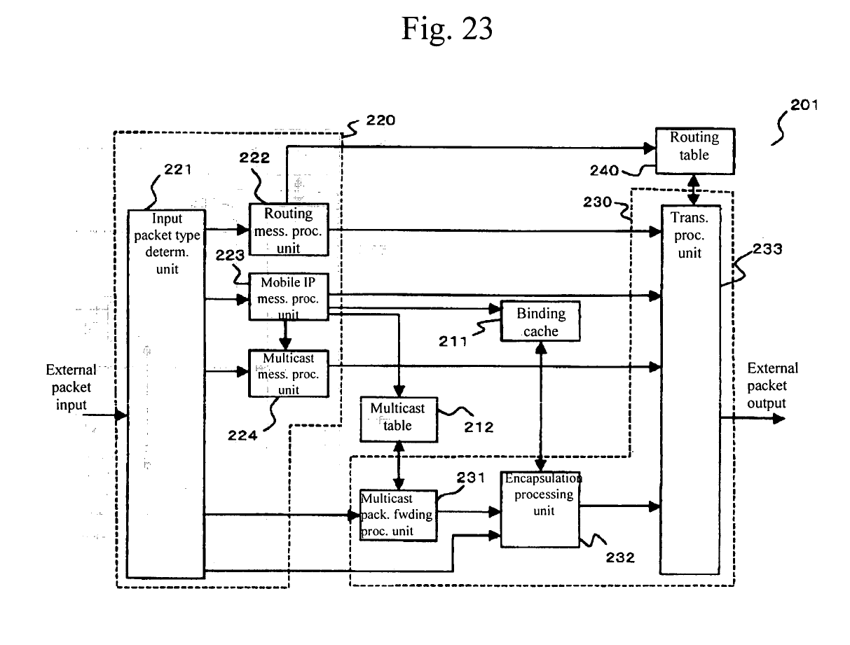

FIG. 23 is a drawing that shows an example configuration of the AR moved from in the present embodiment example.

In FIG. 23, the basic block configuration is the same as the configuration of the HA shown in FIG. 9, but the content of the information handled is different.

In the aforementioned third embodiment example, HA 110 operated based on the correspondence relationship between the HoA used as the mobile node's base address and the mobile node's care-of address CoA.

By contrast, in the current embodiment example, the pre-move old AR (2) 201 operates based on the correspondence relationship between oldCoA—the old care-of address from before the move as the basic address of the mobile node, and the new care-of address newCoA after the move.

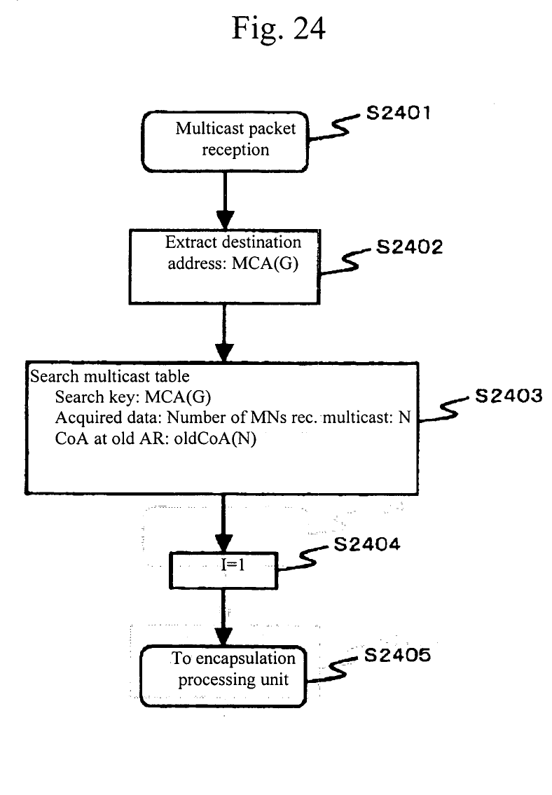

FIG. 24 is a flow chart of the multicast packet forwarding processing unit of the old AR (1) 201, which is substantially identical to the flow chart of the HA shown in FIG. 11.

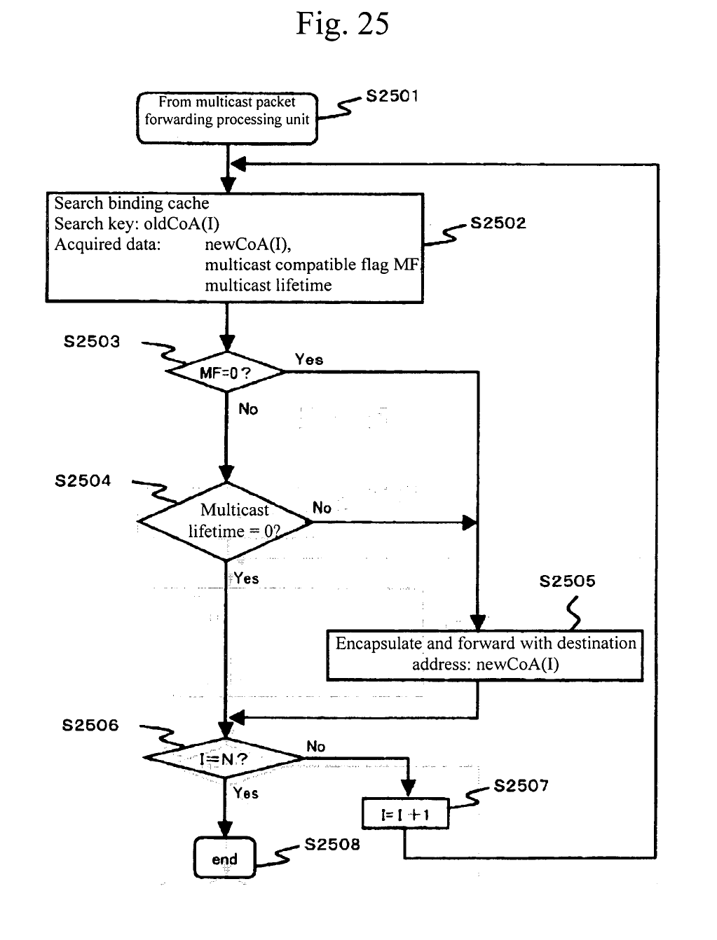

Furthermore, FIG. 25 is a flow chart of the encapsulation processing unit of the old AR (1) 201, which is substantially identical to the flow chart of the HA shown in FIG. 12.

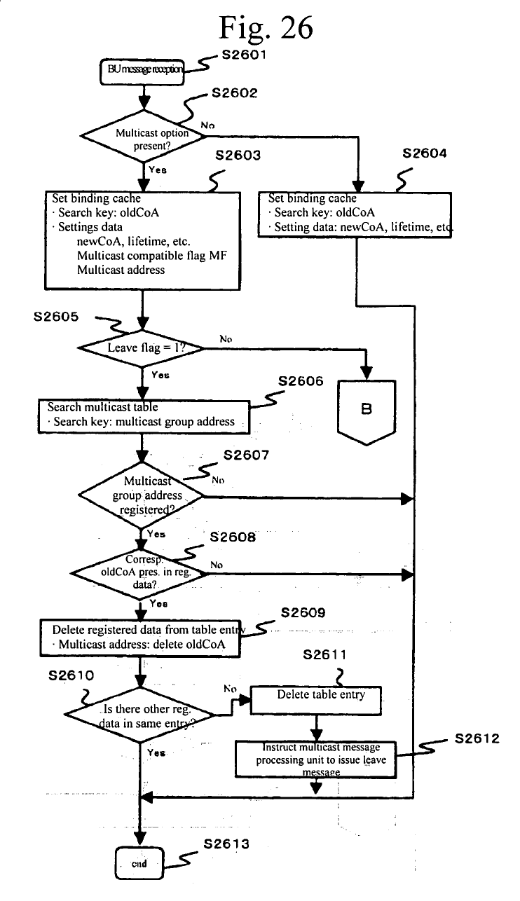

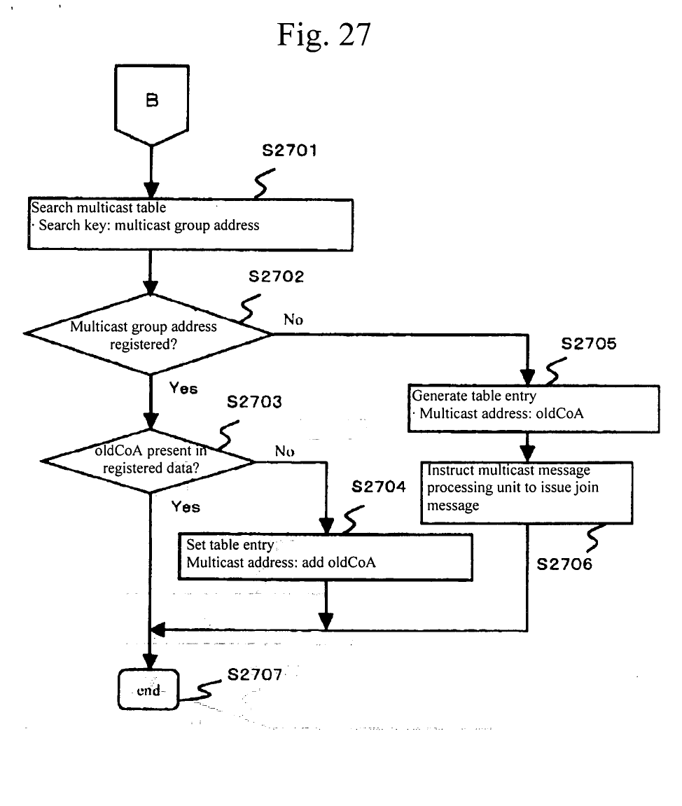

Furthermore, FIG. 26 and FIG. 27 are flow charts (1) and (2) of the mobile IP message processing unit of the old AR (1) 201, which are substantially identical to the flow charts of the HA shown in FIG. 13 and FIG. 14 respectively.

The difference is that, since oldCoA and not HoA is used as the address of the MN corresponding to the multicast group address in the multicast table of the old AR (1) 201, oldCoA is obtained as a result of searching the multicast table.

A further difference is that the binding cache of the old AR (1) 201 likewise registers the newCoA, lifetime, etc. in relation to the oldCoA and not the HoA, and processing such as searching for the newCoA and various multicast options is performed based on this oldCoA.

Processing other than that indicated above is the same as in the operation of HA 110 described in the third embodiment example.

The example configuration of the MN in the present embodiment example is identical to the example configuration of the MN of the third embodiment example shown in FIG. 10.

The difference from the third embodiment example is in the content of the information handled and in the content of its processing.

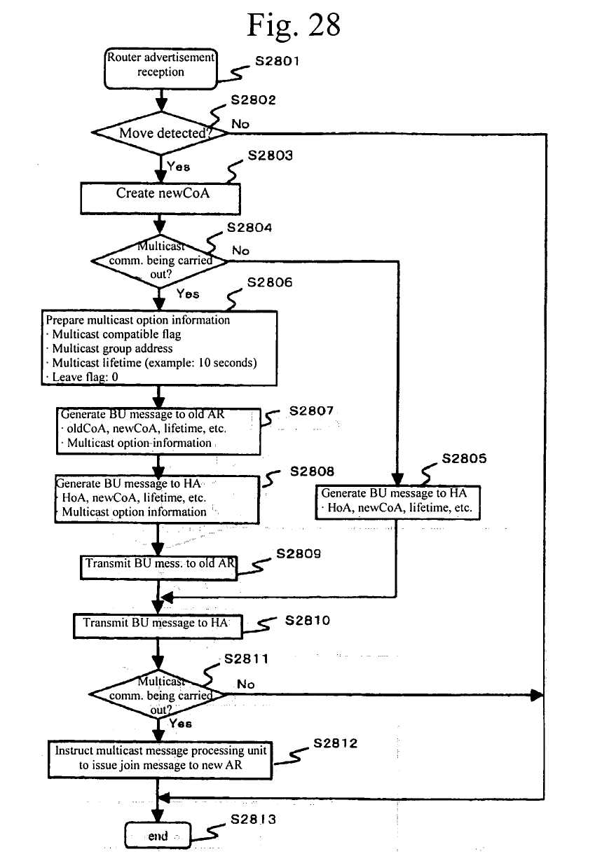

FIG. 28 is a flow chart of the operation at the time of moving of the mobile IP message processing unit of an MN in the present embodiment example, which is substantially identical to the flow chart of the third embodiment example shown in FIG. 18.

The point of difference is that, when a move is detected, a BU message is generated (S2808) and transmitted (S2809) to the old AR as well as to the HA.

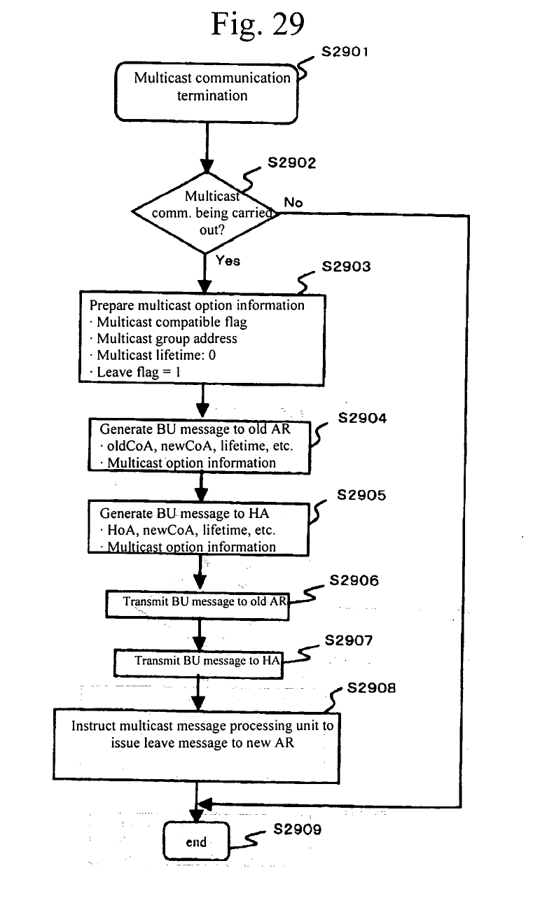

FIG. 29 is a flow chart of the operation at the time of terminating communication of the mobile IP message processing unit in the example configuration of the MN in the present embodiment example, and is substantially identical to the flow chart of the third embodiment example shown in FIG. 19.

The point of difference is likewise that a BU message is generated (S2904) and transmitted (S2906) to the old AR as well as to the HA.

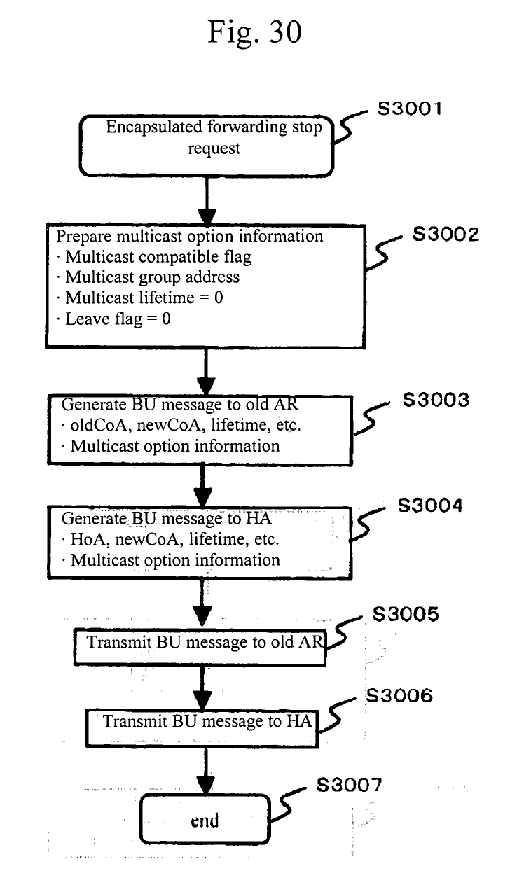

FIG. 30 is a flow chart of the operation at the time of stopping redundant encapsulated forwarding of the mobile IP message processing unit of the MN in the present embodiment example, and is substantially identical to the flow chart of the third embodiment example shown in FIG. 20.

The point of difference is likewise that a BU message is generated (S3003) and transmitted (S3005) to the old AR as well as to the HA.

In FIGS. 21 and 22, it is obvious that the present invention can be applied and the aforementioned effect can be obtained also in cases where many routers are present between the sender 501 and AR (1) 201 and AR (2) 202, and between the sender 501 and the HA 110.

We claim:

1. A packet relay device comprising:
a join request unit operable to transmit a join request to join a multicast group in response to receiving a join instruction to join the multicast group, the join instruction transmitted by a mobile node at least before the mobile node moves between subnetworks; and
a packet forwarding unit operable to forward subsequently received multicast packets for the multicast group for a specified time period to a care-of address in response to receiving location registration information containing the care-of address of the mobile node in a foreign subnetwork to which the mobile node has moved, the location registration information transmitted when the mobile node has moved between subnetworks.

2. The packet relay device according to claim 1, wherein the packet forwarding means is further operable to stop forwarding of the multicast packets in response to receiving a forwarding stop instruction transmitted by the mobile node.

3. The packet relay device according to claim 1, wherein the packet forwarding means is further operable to determine a forwarding time period for the multicast packets based on time period designation information in response to receiving the time period designation information indicating a specified time period, the time period designation information transmitted by the mobile node.

4. A mobile node comprising:
a join instruction unit operable to transmit join instructions to join a multicast group to a location registrar relay device, the location registrar relay device being the recipient of location registration information containing one's own care-of address, at least before the mobile node moves between subnetworks, and
a forwarding request unit operable to transmit a forwarding request to the location registrar relay device, in response to the mobile node moving between subnetworks while participating in the multicast group, whereby multicast packets for the multicast group are subsequently received by the location registrar relay device to be forwarded for a time period to a care-of address of the mobile node after the move.

5. The mobile node according to claim 4, wherein the join instruction unit is further operable to:
transmit a join request to join the multicast group to a relay device in a subnetwork to which the mobile node is attached when the mobile node newly joins a multicast group; and
transmit a join instruction to join the multicast group to the location registrar relay device.

6. The mobile node according to claim 4, further comprising a forwarding stop instruction unit operable to transmit to the location registrar relay device a forwarding stop instruction to stop forwarding of multicast packets by the location registrar relay device once multicast packets are received from a multicast group based on a join request after transmitting the join request to join the multicast group.

7. A mobile node according to claim 4, further comprising a time period designation operable to transmit information indicating a specified period of time as the time period to the location registrar relay device when a subnetwork to which the mobile node has moved has a multicast packet delivery function; and
transmit information indicating that forwarding should be continued as the time period to the location registrar relay device when the subnetwork to which the mobile node has moved has no multicast packet delivery function.

8. A packet forwarding method comprising the steps of:
notifying a home agent for a mobile node that receives multicast packets whether a foreign subnetwork to which the mobile node has moved is a multicast protocol compatible subnetwork;
encapsulating and forwarding, at the home agent, the multicast packets to a care-of address of the mobile node for a time period if, based on content of the notification, the foreign subnetwork to which the mobile node has moved is a multicast protocol compatible subnetwork; and
continuing to encapsulate and forward, at the home agent, 11 the multicast packets to the care-of address regardless of the time period if the foreign subnetwork is not a multicast protocol compatible subnetwork.

9. The packet forwarding method according to claim 8, further comprising the step of:
including information indicating whether the foreign subnetwork is multicast protocol compatible in a location registration message.

10. The packet forwarding method according to claim 8, further comprising the step of:
statically determining, at the home agent, the time period for performing encapsulated forwarding.

11. The packet forwarding method according to claim 8, further comprising the step of:
indicating to the home agent, from the mobile node, that the time period that the home agent forwards multicast packets to the mobile node.

12. A packet forwarding method comprising the steps of:
notifying a relay device to which a mobile node that receives multicast packets was connected in a subnetwork that the mobile node is moving from as to whether a foreign subnetwork to which the mobile node is moving is a multicast protocol compatible subnetwork;
encapsulating and forwarding, at the relay device, the multicast packets for a time period to a care-of address of the mobile node in the foreign network to which the mobile node has moved if, based on content of the notification, the foreign subnetwork to which the mobile node has moved is a multicast protocol compatible subnetwork; and
continuing to encapsulate and forward, at the relay device, the multicast packets to the care-of address regardless of the time is period if the foreign subnetwork to which the mobile node has moved is not a multicast protocol compatible subnetwork.

13. The packet forwarding method according to claim 12, further comprising the step of:
including information indicating whether the foreign subnetwork is multicast protocol compatible in a location registration message.

14. A home agent comprising:
a binding cache operable to manage foreign locations of mobile nodes to be managed;
a multicast packet forwarding processing unit operable to forward multicast packets; and
a packet processing unit operable to perform encapsulated forwarding of multicast packets for a specific time period depending on whether multicast packets can be received at a foreign location of a mobile node.
